(19) United States
(12) Patent Application Publication
(10) Pub. No.: US 2024/0312033 A1
(43) Pub. Date: Sep. 19, 2024

(54) METHOD TO REGISTER FACIAL MARKERS

(71) Applicant: Lucio Dorneles MOSER, Vancouver (CA)

(72) Inventor: Lucio Dorneles MOSER, Vancouver (CA)

(73) Assignee: Digital Domain Virtual Human (US), Inc., Los Angeles, CA (US)

(21) Appl. No.: 18/679,323

(22) Filed: May 30, 2024

Related U.S. Application Data
(63) Continuation of application No. PCT/CA2022/051753, filed on Nov. 30, 2022.
(60) Provisional application No. 63/287,031, filed on Dec. 7, 2021.

(51) Int. Cl. G06T 7/33; G06T 7/55; G06T 7/80; G06T 13/40; G06T 17/20

(52) U.S. Cl. CPC G06T 7/344; G06T 7/55; G06T 7/80; G06T 13/40; G06T 17/20; G06T 2207/30201; G06T 2207/30204; G06T 2207/30244

(57) ABSTRACT

A method for registering facial markers on an actor to a 3D mesh is provided. The method comprises obtaining an animated face geometry; obtaining shot data of a face of actor with markers applied thereon; performing a matrix decomposition on the plurality of frames of the 3D mesh to obtain a decomposition basis; selecting a shot data frame from among the series of shot data frames to be a neutral frame and generating a 3D face reconstruction; performing a solve operation to determine a solved 3D face geometry that approximates the 3D face reconstruction; and projecting 2D locations of the markers from the shot data onto the 3D mesh corresponding to the solved 3D face geometry using the shot data.

### CROSS-REFERENCE TO RELATED APPLICATIONS

This application is a continuation of Patent Cooperation Treaty (PCT) application No. PCT/CA2022/051753 having an international filing date of 30 Nov. 2022, which in turn claims priority from, and for the purposes of the United States of America, the benefit of 35 USC §119 in connection with, U.S. application No. 63/287,031 filed 7 Dec. 2021. All of the applications referred to in this paragraph are hereby incorporated herein by reference.

### TECHNICAL FIELD

This application relates generally to facial motion capture and, in particular, to methods and systems for registering points (e.g. markers) on a captured face onto a three dimensional (3D) facial model.

### BACKGROUND

In computer graphic (CG) animation, it is common to represent objects (such as the faces of CG characters) using three-dimensional (3D) meshes comprising polyhedra (defined by vertices and edges between vertices) or 3D surface meshes comprising polyhedrons (also defined by vertices and edges between the vertices). A 3D object can be animated by selectively deforming some or all of the vertices-e.g. in response to model(s) of applied forces and/or the like.

Marker-based facial motion capture is a popular technique used in 3D computer graphics for implementing performance-based facial animation—e.g. where the facial characteristics of a CG character are based on the captured performance of an actor. In marker-based facial motion capture, markers are painted or otherwise marked on an actor's face, tracked over time (e.g. by a plurality of cameras on a head-mounted camera (HMC) set up or by a plurality of cameras otherwise arranged for 3D image capture), and triangulated to positions in 3D space. The triangulated marker positions (e.g. on one of the tracked frames showing a neutral expression) are then mapped to locations on a 3D CG model representing the actor's face (e.g. a high-resolution 3D CG surface mesh of the actor's face) in a neutral expression to establish a correspondence between the triangulated 3D positions of the facial motion capture markers and corresponding points on the 3D CG model/mesh. This process of mapping the triangulated 3D positions of the facial motion capture markers to corresponding locations on the 3D CG model/mesh is known as marker registration.

Marker registration can be a challenging process and can be prone to errors. In general, markers must be re-applied to the face of an actor for each motion capture recording session. Because the markers applied in each motion capture session may be applied at slightly different locations, some prior art motion capture pipelines require that marker registration be re-performed for every motion capture session to mitigate errors associated with different marker placements. Some motion capture methods require a make-up artist to carefully paint the markers back onto the face of the actor in their previous positions (i.e. the position of the markers in a previous motion capture recording session), following a template or a mask from the previous application, to minimize the need for a new marker registration at each motion capture session. Some motion capture pipelines require artists to manually correct mistakes made during the motion capture recording sessions (e.g. by eyeballing the marker locations on to the high-resolution neutral mesh). These techniques typically involve guesswork which is prone to errors and does not guarantee consistent marker registration across different recording sessions. Poor marker registration can undesirably lead to poor reconstruction of the actor's performance on the 3D CG character surface mesh.

Marker registration can also be time consuming. For example, some facial marker registration techniques require the actor's face to be scanned each time the markers are reapplied to obtain a high-resolution 3D reconstruction of the actor's head before the markers can be registered onto the 3D CG facial mesh. Scanning usually involves the actor staying static in a neutral pose, so that their face can be captured using cameras oriented at a number of different angles, so that the images from the plurality of cameras can be imported into commercial grade multi-view reconstruction software to build a textured high resolution 3D reconstruction of the actor's head. The process of scanning the actor to obtain a high-resolution 3D reconstruction can be especially time consuming. It is not practical, and sometimes impossible, to scan the actor multiple times a day, which is typically required for providing good marker registration using current techniques.

Some prior art marker registration techniques involve using non-rigid registration software to register a scanned 3D reconstruction of the actor's face (in a neutral pose) to the 3D CG mesh. These prior art marker registration techniques require user guidance and depend on geometric priors to spread the distortion evenly as one 3D geometry is registered to the other. Geometric priors are not data driven. Instead, geometric priors typically depend on energies derived from the mesh itself which can be used to shape and/or limit how the mesh will move. For example, for a given facial geometry, one can compute a metric indicative of the amount of stretching and/or bending (relative to the neutral pose) and limits can be place on such stretching and/or bending. Because geometric priors are not data driven, they often do not reflect the non-linear behavior encountered in the facial skin. Further, at the conclusion of the non-rigid registration, a human must still locate the markers in the aligned reconstruction and create the mapping to a corresponding point on the aligned 3D CG mesh.

Some prior art marker registration techniques involve selecting one frame (a 2D image) from the scanning session where the actor was in a neutral expression, determining the 3D marker positions associated with that frame, applying a rigid alignment procedure that finds a rigid transformation that aligns the 3D marker positions to previously registered neutral pose marker positions in a way which spreads mismatch errors evenly, applying this rigid transformation to the scanned 3D neutral reconstruction, and finally registering the transformed marker locations to the 3D CG mesh using a closest point in the surface algorithm. In these registration techniques, markers that have changed position will impact the rigid registration results. Also differences between the two neutral poses will degrade the rigid alignment and the efficacy of the closest point on the surface algorithm.

There remains a need for improved systems and methods which expedite and/or mitigate errors during the process of marker registration. There is a particular need for systems and methods which improve the consistency of marker registration across different motion capture recording sessions. There is also a particular need for improved systems and methods which allow marker registration to be performed without the need to obtain a high-resolution 3D reconstruction of the actor's face.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Aspects of the invention includes, without limitation, systems and methods for marker registration.

One aspect of the invention provides a computer implemented method for registering markers applied on a face of an actor to a computer-based three-dimensional (3D) mesh representative of a face geometry of the actor. The method comprises: obtaining an animated face geometry comprising a plurality of frames of a computer-based 3D mesh representative of a face geometry of the actor, the 3D mesh comprising: for each of the plurality of frames, 3D locations of a plurality of vertices; and identifiers for a plurality of polygons, each polygon defined by ordered (e.g. clockwise or counter-clockwise) indices of a corresponding group of vertices; obtaining shot data of a face of actor with markers applied thereon, the shot data comprising first footage of the face captured over a series of shot data frames from a first orientation and second footage of the face captured from a second orientation over the series of shot data frames, the first and second orientations different than one another; performing a matrix decomposition on the plurality of frames of the 3D mesh to obtain a decomposition basis which at least approximately spans a range of motion of the vertices over the plurality of frames; selecting a shot data frame from among the series of shot data frames to be a neutral frame and generating a 3D face reconstruction based on the first footage and the second footage of the neutral frame; performing a solve operation to determine a solved 3D face geometry that approximates the 3D face reconstruction, the solved 3D face geometry parameterized by solved face geometry parameters comprising: a set of decomposition weights which, together with the decomposition basis, can be used to reconstruct the 3D mesh in a particular face geometry; a set of rotation parameters; and a set of translation parameters; and projecting 2D locations of the markers from the shot data onto the 3D mesh corresponding to the solved 3D face geometry using the shot data. Projecting the 2D locations of the markers from the shot data onto the 3D mesh corresponding to the solved face geometry comprises, for each marker, determining a set of marker registration parameters, the set of marker registration parameters comprising: a particular polygon identifier which defines a particular polygon of the 3D mesh onto which the marker is projected; and a set of registration parameters which defines where in the particular polygon the marker is projected.

The polygons of the mesh may be triangles defined by the indices of 3 corresponding vertices.

For each marker, the set of parameters which defines where in the particular polygon the marker is projected may comprise a set of barycentric coordinates.

Performing the matrix decomposition may comprise performing a principal component analysis (PCA) decomposition and the blendshape basis may comprise a PCA basis.

Obtaining the animated face geometry may comprise performing a multi-view reconstruction of on the face of the actor.

Obtaining the animated face geometry may comprise animation retargeting a performance of a different actor onto the actor.

Obtaining the animated face geometry may be performed in advance and independently from obtaining shot data of the face of the actor.

Generating the 3D face reconstruction may be further based on camera calibration data relating to cameras used to obtain the first footage and the second footage.

The camera calibration data may comprise, for each camera, camera intrinsic parameters comprising any one or more of: data relating to the lens distortion, data relating to the focal length of the camera and data relating to the principal point.

The camera calibration data may comprise, for each camera, camera extrinsic parameters comprising camera rotation parameters (e.g. a rotation matrix) and camera translation parameters (e.g. a translation) that together (e.g. by multiplication) define a location and orientation of the camera in a 3D scene.

The method may comprise obtaining at least some of the camera calibration data by capturing a common grid displayed in front of the first and second cameras.

The first and second footages may be captured by corresponding first and second cameras supported by a head-mounted camera device mounted to the head of the actor.

Generating the 3D face reconstruction may comprise generating a shot data 3D mesh based on the first footage and the second footage of the neutral frame.

Generating the 3D face reconstruction may comprise generating a depth map based on the first footage and the second footage of the neutral frame. The depth map may comprise an image comprising a two-dimensional array of pixels and a depth value assigned to each pixel.

Generating the depth map may comprise: generating a shot data 3D mesh based on the first footage and the second footage of the neutral frame; and rendering the shot data 3D mesh from the perspective of a notional camera.

Rendering the shot data 3D mesh from the perspective of a notional camera may comprise rendering the shot data 3D mesh from the perspective of a plurality of notional cameras, to thereby obtain a corresponding plurality of depth maps, each depth map comprising an image comprising a two-dimensional array of pixels and a depth value assigned to each pixel.

Performing the solve operation to determine the solved 3D face geometry may comprise minimizing an energy function to thereby determine the solved face geometry parameters.

The energy function may comprise a first term that assigns cost to a difference metric between the solved face geometry and the 3D face reconstruction. The first term may comprise, for each vertex of the 3D mesh, a difference between a depth dimension of the vertex of the solved face geometry and a corresponding depth value extracted from the 3D face reconstruction.

The method may comprise, for each vertex of the 3D mesh, extracting the corresponding depth value from the 3D face reconstruction. Extracting the corresponding depth value from the 3D face reconstruction may comprise: determining, for the vertex, corresponding projected pixel coordinates; and interpolating depth values prescribed by the 3D face reconstruction at the corresponding projected pixel coordinates. Interpolating the depth values prescribed by the 3D face reconstruction may comprise bilinear interpolation of the depth values prescribed by a plurality of pixels of a depth map.

The method may comprise, for each vertex of the 3D mesh, extracting the corresponding depth value from the 3D face reconstruction. Extracting the corresponding depth value from the 3D face reconstruction may comprise ray tracing from an origin, through the vertex of the 3D mesh and onto a shot data mesh of the 3D face reconstruction.

The first term (of the energy function) may comprise, for each vertex of the 3D mesh, application of a per-vertex mask to the difference between the depth dimension of the vertex of the solved face geometry and the corresponding depth value extracted from the 3D face reconstruction. The per-vertex mask may comprise a binary mask which removes from the first term vertices in which a confidence in the 3D face reconstruction is low. The per-vertex mask may comprise a weighted mask which assigns a weight to each vertex, a magnitude of the weight based on a confidence in the 3D face reconstruction at that vertex.

The difference metric (in the first term of the energy function) may comprise a robust norm that switches between a L1 norm and a L2 norm based on a user-configurable parameter Δ.

The energy function may comprise a second term that assigns costs to solved face geometries that are unlikely based on using the animated face geometry as an animation prior. The second term may be based at least in part on a precision matrix computed from the animated face geometry. The precision matrix may be based at least in part on an inverse of a covariance matrix of the animated face geometry. The second term may be based at least in part on a negative log likelihood computed from the precision matrix.

The method may comprise: identifying a plurality of key points from among the plurality of vertices; extracting a keypoint animation from the animated face geometry, the extracted keypoint animation comprising, for each of the plurality of frames, 3D locations of the key points; and computing the precision matrix based on the keypoint animation. Computing the precision matrix based on the keypoint animation may comprise computing an inverse of a covariance matrix of the keypoint animation.

The energy function may comprise a third term comprising user-defined constraints. The user-defined constraints may comprise user-specified 2D or 3D locations for particular vertices and the third term may assign cost to deviations of the particular vertices from these 2D or 3D locations.

Minimizing the energy function to thereby determine the solved face geometry parameters may comprise: minimizing the energy function a first time while varying the rotation parameters and the translation parameters while maintaining the decomposition weights constant to thereby determine a first order set of rotation parameters and a first order set of translation parameters; and starting with the first orders set of rotation parameters and the first order set of translation parameters, minimizing the energy function a second time while varying the rotation parameters, the translation parameters and the decomposition weights to thereby determine a second order set of rotation parameters, a second order set of translation parameters and a first order set of decomposition weights.

The solved face geometry parameters may comprise: the second order set of rotation parameters, the second order set of translation parameters and the first order set of decomposition weights.

Minimizing the energy function to thereby determine the solved face geometry parameters may comprise: introducing one or more user-defined constraints into the energy function to thereby obtain an updated energy function; starting with the second order set of rotation parameters, the second order set of translation parameters and the first order set of decomposition weights; and minimizing the updated energy function while varying the rotation parameters, the translation parameters and the decomposition weights to thereby determine the solved face geometry parameters.

Performing the solve operation to determine the solved 3D face geometry may comprise, for each of a number of iterations: starting with different initial rotation parameters and different initial translation parameters; and minimizing an energy function to thereby determine candidate solved face geometry parameters comprising: a set of candidate decomposition weights; a set of candidate rotation parameters; and a set of candidate translation parameters; and, after the plurality of iterations, determining the solved face geometry parameters based on the candidate solved face geometry parameters.

Projecting the 2D locations of the markers from the shot data onto the 3D mesh corresponding to the solved face geometry may comprise, for each marker: determining a first pixel representative of a location of the marker in the first footage of the neutral frame; determining a second pixel representative of a location of the marker in the second footage of the neutral frame; triangulating the first and second pixels using camera calibration data to thereby obtain 3D coordinates for the marker; and ray tracing from an origin through the 3D coordinates of the marker and onto the 3D mesh corresponding to the solved face geometry, to thereby determine a location on the 3D mesh corresponding to the solved face geometry onto which the marker is projected.

Determining the first pixel representative of a location of the marker in the first footage of the neutral frame may comprise determining the first pixel to be a center of the marker in the first footage of the neutral frame. Determining the second pixel representative of a location of the marker in the second footage of the neutral frame may comprise determining the second pixel to be a center of the marker in the second footage of the neutral frame.

The method may comprise determining 3D positions of the markers on a neutral configuration of the 3D mesh based on the marker registration parameters.

Determining 3D positions of the markers on the neutral configuration of the 3D mesh may comprise, for each marker, performing a calculation according to:

$${\vec{Pos}}_{k} = {c}_{1} ( {\vec{V}}_{1 k} ) + {c}_{2} ( {\vec{V}}_{2 k} ) + {c}_{3} ( {\vec{V}}_{3 k} )$$

where: k is the polygon identifier of the particular polygon of the 3D mesh onto which the marker is projected; (c₁, c₂, c₃) are the set of parameters which defines wherein the particular polygon the marker is projected; and [symbol] are locations of the vertices that define the k^{th} polygon of the neutral configuration of the 3D mesh.

Determining 3D positons of the marks on the neutral configuration of the 3D mesh may comprise, for each marker, performing a calculation according to:

$${\vec{Pos}}_{k} = {\sum }_{i = 1}^{N} {c}_{i} ( {\vec{V}}_{ik} )$$

where: k is the polygon identifier of the particular polygon of the 3D mesh onto which the marker is projected; N is the number of vertices that define the polygon, (c₁, c₂, . . . c_{N}) are the set of parameters which defines wherein the particular polygon the marker is projected; and [symbol] are locations of the vertices that define the kth polygon of the neutral configuration of the 3D mesh.

Another aspect of the invention provides methods having any new and inventive steps, acts, combination of steps and/or acts or sub-combination of steps and/or acts as described herein.

Another aspect of the invention provides an apparatus comprising one or more processors configured (e.g. by suitable software) to perform any of the methods described herein.

Another aspect of the invention provides a computer program product comprising a non-transient computer-readable storage medium having data stored thereon representing software executable by a process, the software comprising instructions to perform any of the methods described herein.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A depicts a representation of an exemplary 3D object (a 3D face). FIG. 1B is a 3D CG polygonal mesh which defines the 3D surface shape FIG. 1A object. FIG. 1C is a simplified schematic representation of the 3D CG polygonal mesh shown in FIG. 1B. FIG. 1D is an image of an actor with markers applied on his face. FIGS. 1E-F show different view of markers registered on the FIG. 3D face.

FIG. 2 is a flowchart depicting a method for registering markers on an actor onto a 3D object according to an example embodiment of the invention.

FIG. 3 is a flowchart depicting a method for compressing an animated facial geometry into a plurality of blend shapes according to an example embodiment of the invention.

FIG. 4 is a schematic illustration of an exemplary head mounted camera (HMC) mounted on an actor.

FIG. 5 is a flowchart depicting a method for creating a 3D reconstruction based on footage captured from an HMC according to an example embodiment of the invention. FIG. 5A shows an example 3D reconstruction (in this case a rendering of a 3D mesh).

FIG. 6 is a flowchart depicting an exemplary method of non-rigid registration to the 3D reconstruction created by the method shown in FIG. 5 according to particular embodiment. FIG. 6A is a flowchart depicting an exemplary method of minimizing an energy function of the FIG. 6 method.

FIG. 7 is a flowchart depicting an exemplary method of registering markers on the 3D reconstruction to a face geometry according to a particular embodiment.

FIG. 8 depicts an exemplary system for performing one or more methods described herein (e.g. the methods of FIGS. 2, 3, 5, 6, 6A and 7) according to a particular embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

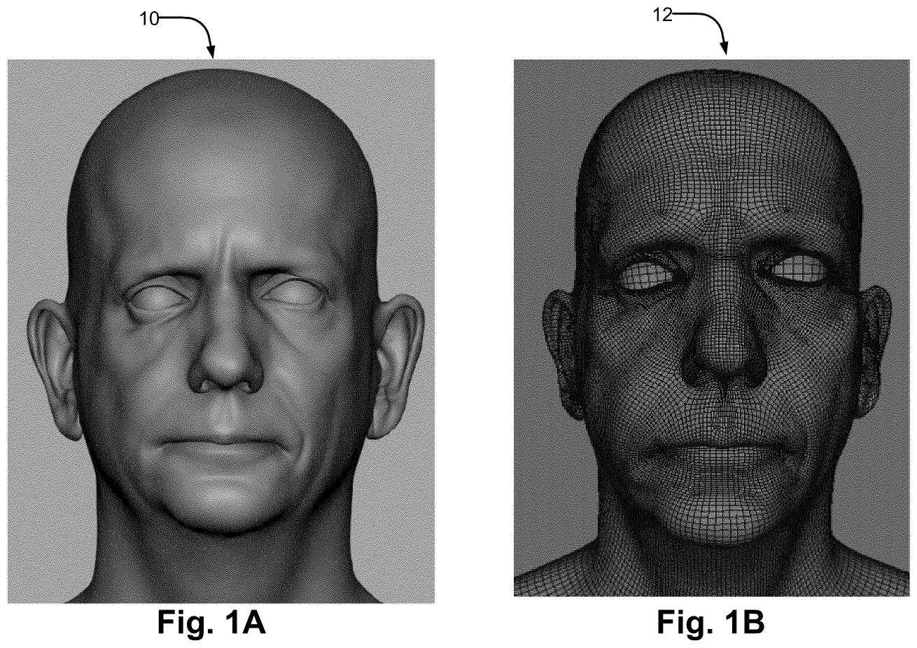

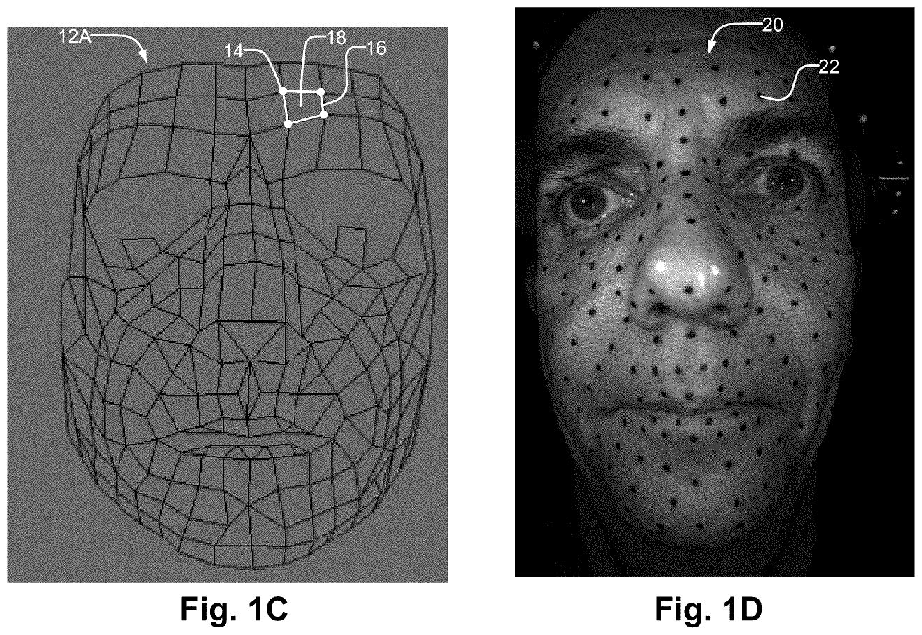

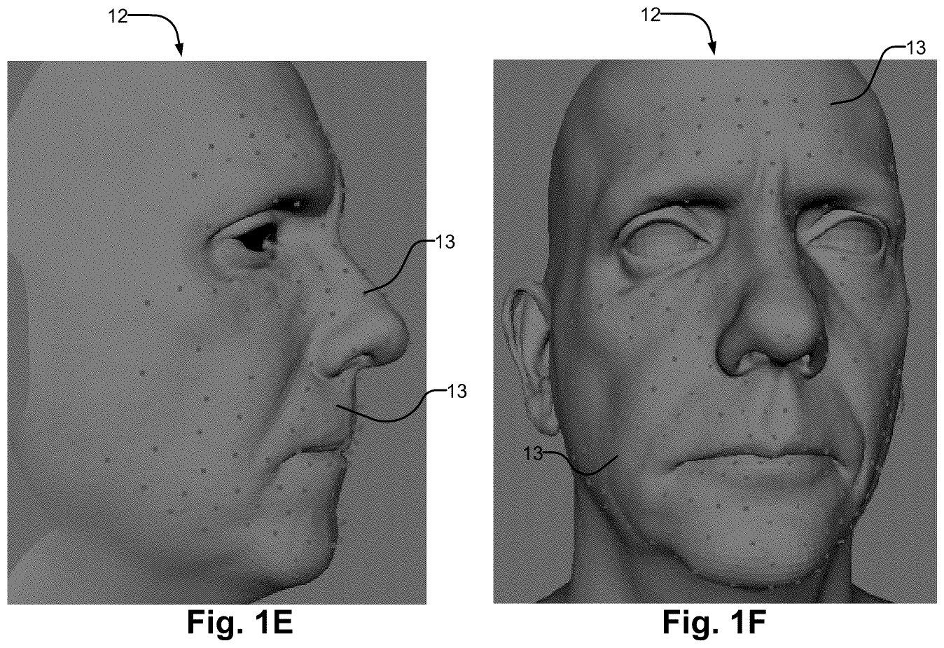

FIG. 1A depicts a representation of an exemplary 3D object (e.g. a 3D face of a CG

character) 10, the surface of which may be modelled, using suitable configured computer software and hardware and according to an exemplary embodiment, by the polygonal 3D mesh 12 shown in FIG. 1B. 3D object 10 may be based on the face of an actor 20 (e.g. a person—see FIG. 1D). 3D face mesh 12 may also be referred to herein as a representation of 3D face geometry 12 or, for brevity, 3D geometry 12. 3D face mesh 12 may comprise a plurality of vertices 14, a plurality of edges 16 (extending between pairs of vertices) and a plurality of polygonal faces 18 (defined by ordered (e.g. clockwise or counterclockwise) indices or vertices 14 and, optionally, corresponding edges 16 which may be defined by pairs of vertex indices). The faces 18 of 3D face mesh 12 collectively model the surface shape (geometry) of 3D face 10. 3D face 10 shown in FIG. 1A is a computer-generated (CG) grey-shaded rendering of 3D face mesh 12 shown in FIG. 1B.

For illustrative purposes, a simplified schematic representation 12A of polygon mesh 12 is shown in FIG. 1C. FIG. 1C is provided to help illustrate the relationship between vertices 14, edges 16, and polygons 18. As illustrated in FIG. 1C, edges 16 are lines which are defined between pairs of vertices 14 (e.g. defined by pairs of vertex indices). As illustrated in FIG. 1C, a closed set of edges 16 (or a corresponding ordered set of vertex indices) form a polygon 18. Each of the polygons 18 shown in FIG. 1C has four edges and for vertices to form a quadrilateral, but this is not necessary. Polygons 18 may have any other suitable number of edges or vertices. For example, polygons 18 may have three edges and three vertices to form a triangle.

The position of each vertex 14 is typically defined by an x-coordinate, a y-coordinate, and a z-coordinate (3D coordinates), although other 3D coordinate systems are possible. The coordinates of each vertex 14 may be stored in a matrix. Such a matrix may, for example, be of shape [v, 3] where v is the number of vertices 14 of polygon mesh 12 (i.e. each row of the matrix corresponds to a vertex 14, and each column of the matrix corresponds to a coordinate). The geometries of edges 16 and polygons 18 may be defined by the positions of their corresponding vertices 14.

3D face mesh 12 may, for example, have a vertex density which is on the order of 3,000 to 60,000 vertices. A high definition 3D face mesh 12 may have a vertex density which is typically on the order of 30,000 vertices or more. High definition 3D face meshes can realistically depict detailed facial features of the actor 20 to provide a high degree of fidelity.

FIG. 1D is an image of the face of actor 20. 3D face mesh 12 of the illustrated embodiment is modelled based on the face of actor 20. In the FIG. 1D image, a plurality of markers 22 have been applied on the face of actor 20.

One aspect of the invention provides a method for registering markers 22 from the face of an actor 20 to corresponding locations on 3D face geometry 12-e.g. to establish a mapping between each of the markers 22 applied on the face of actor 20 and a corresponding 3D point 13 on 3D face geometry 12 (e.g. see the representations in FIGS. 1E-F, where 3D points 13 corresponding to markers 22 are shown on renderings of 3D face geometry 12). While the representations of 3D face geometry 12 shown in FIGS. 1E-1F do not expressly show vertices 14, edges 16 or faces 18, it will be appreciated that the 3D locations of points 13 on face geometry 12 may correspond to vertices 14, points on edges 16, or points on faces 18 of polygon mesh 12. Registering markers 22 from the face of an actor onto 3D face geometry 12 in this manner allows 3D face geometry 12 to be animated or otherwise driven by the facial movements of actor 20 (i.e. the shape of 3D face mesh 12 can be deformed based on movements of markers 22 after they have been registered onto corresponding points 13 on face geometry 12).

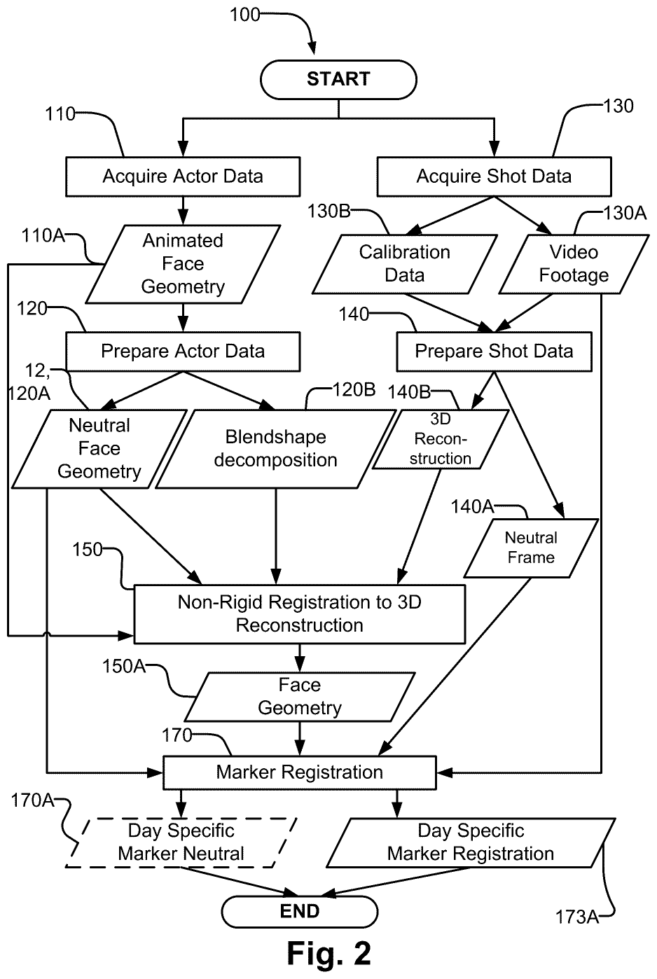

FIG. 2 is a flowchart depicting a method 100 for registering markers 22 (applied on the face of an actor 20) onto a 3D face geometry 12 according to an example embodiment of the invention. Method 100 may be performed by a computer system comprising one or more processors configured to operate suitable software for performing method 100. Method 100 of the illustrated embodiment begins at step 110. Step 110 comprises capturing a facial performance of an actor 20 to obtain an animated face geometry 110A. The step 110 actor-data acquisition may involve a performance by actor 20 of a controlled execution of one or more facial expressions. In a currently preferred embodiment, the step 110 performance comprises the actor's execution of a neutral expression. By way of example, the step 110 actor-data acquisition may involve a performance by actor 20 of moving from a neutral expression to a particular facial expression (e.g. a smiling expression) and back to the neutral expression. This type of performance may be repeated for several different particular facial expressions.

Step 110 is typically performed using suitable facial motion capture hardware and related software in a motion-capture studio comprising plurality of cameras and idealized light conditions. Step 110 may involve a multi-view reconstruction (e.g. “scanning”) of the face of actor 20. For example, step 110 may involve capturing images of the face of actor 20 from several angles/viewpoints and creating a 3D reconstruction of the step 110 performance. Step 110 may be performed via 3D capture of the facial expressions of actor 20 using markerless and/or marker-based surface motion-capture hardware and motion-capture techniques known in the art (e.g. DI4D™ capture, the type of motion capture described by T. Beeler et al. 2011. High-Quality Passive Facial Performance Capture Using Anchor Frames. ACM Trans. Graph. 30, 4, Article 75 (July 2011), 10 pages, the type of motion capture described in G. Fyffe et al. 2017. Multi-View Stereo on Consistent Face Topology. CGF 36 (2017), 295-309 and/or the like). Alternatively or additionally, step 110 may be performed via so-called animation retargeting. For example, step 110 may be performed by retargeting (typically manually) the performance of one actor onto the expressions of another actor. This may be done, for example, by determining a difference between the neutral poses of the two actors and then applying this difference to the new actor's other expressions. Step 110 may be performed using any suitable technique and/or technology to generate an animated face geometry 110A wherein the face of actor 20 deforms over a desirable (e.g. somewhat realistic) range of motion (ROM).

In currently preferred embodiments step 110 generates (and animated face geometry 110A comprises or is convertible to) a high resolution cloud of 3D points which move according to the facial movements made by actor 10 during the step 110 performance. Animated face geometry 110A movement of the high resolution point cloud may be stored across a succession of frames, which may range, for example, from 1,000 to 10,000 frames. In an example embodiment, step 110 comprises capturing about 60 seconds of a facial performance of actor 20 at about 60 frames per second, so that animated face geometry 110A comprises about 3,600 frames of animated geometry data. Each frame of the animated geometry data 110A may comprise several thousand or several tens of thousands (e.g. 10,000-20,000) of 3D points (vertices). The position of each of the 3D vertices can move or vary between frames, based on the facial motion of actor 20 in the step 110 performance.

In some embodiments, animated face geometry 110A is stored in a matrix A of shape [a, b], where a corresponds to the number of frames of animated face geometry 110A and b corresponds to the number of “features” in a frame. That is, each row of matrix A corresponds to a frame of animated face geometry 100A and each column of matrix A corresponds to a feature of animated face geometry 110A. The number of features is typically three times the number of vertices or points (i.e. each vertex has an x-position, a y-position, and a z-position). For example, an animated face geometry 110A having 10,000 vertices and 1,000 frames may be stored in a matrix A of shape [1000, 30000] where each row corresponds to a frame and each column corresponds to a feature of animated face geometry 110A.

As described in more detail elsewhere herein, step 110 may be performed in advance of or after acquiring shot data in step 130. That is, step 110 may be performed independently from the shot data acquisition step 130 (i.e. step 110 does not need to be performed at the same time or even on the same day as shot data acquisition step 130). In some embodiments, step 110 is performed several days in advance of performing shot data acquisition step 130. Since step 110 typically involves generating a high resolution animated face geometry 110A, step 110 may take more time to perform than shot data acquisition performed in step 130. In such circumstances, it may be preferable to perform step 110 separately from performing shot data acquisition in step 130 to prevent performance of step 110 from slowing down performance of step 130.

As described above, step 110 may involve marker-based surface motion-capture but this is not necessary. In some embodiments, animated facial geometry 110A is generated in step 110 without applying any markers to the face of actor 20.

After obtaining animated facial geometry 110A in step 110, method 100 continues to step 120 where actor-specific data (e.g. neutral face geometry 120A and blend shapes 120B) are prepared based on animated facial geometry 110A. At step 120, a neutral face geometry 120A is extracted from animated facial geometry 110A. In some embodiments, extracting neutral face geometry 120A from animated facial geometry 110A comprises selecting (manually, with computer-assistance, or automatically) a frame (of animated facial geometry 110A), where the face of actor 20 exhibits their neutral expression (i.e. a neutral frame) and defining the configuration (e.g. 3D point/vertex locations) of the animated face geometry 110A in the selected neutral frame as the neutral face geometry 120A. In some embodiments, extracting neutral face geometry 120A from animated facial geometry 110A comprises selecting multiple neutral frames and creating the neutral face geometry 120A by processing the positions of the 3D points of the animated face geometry 110A in the selected neutral frames. For example, neutral face geometry 120A may be created by averaging or otherwise combining the positions of the 3D points of the animated face geometry 110A in the selected neutral frames.

Neutral face geometry 120A may also be referred to herein as 3D face geometry 12 (e.g. as described above) for brevity. As described above, aspects of the invention relate to methods and systems of registering markers 22 (applied on an actor 20) onto 3D face geometry 12, 120A.

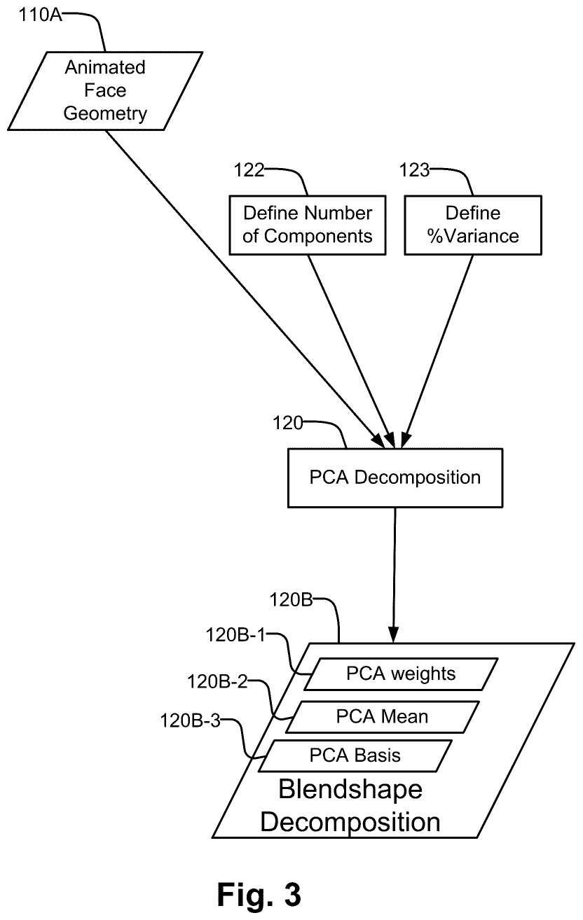

In the example embodiment illustrated in FIG. 2, step 120 of method 100 also comprises compressing animated facial geometry 110A to provide a blendshape decomposition 120B. FIG. 3 illustrates the step 120 method for generating blendshape decomposition 120B according to a particular embodiment which involves principal component (PCA) decomposition. In some embodiments, step 120 uses a PCA blendshape decomposition process which retains some suitable percentage (e.g. a pre-set or user-configurable percentage which may be greater than 90%) of the variance 123 of the poses (frames) of animated facial geometry 110A. In some embodiments, step 120 uses a PCA blendshape decomposition process which limits the number 122 of blendshapes (principal components) used to compress of the poses (frames) of animated facial geometry 110A. It will be understood that the step 120 blendshape decomposition (which is described herein as being a PCA decomposition) could, in general, comprise any suitable form of matrix decomposition technique or dimensionality reduction technique (e.g. independent component analysis (ICA), non-negative matrix factorization (NMF), FACS-based matrix decomposition and/or the like) or other geometry compression technique (e.g. deep learning based geometry compression techniques). For brevity, blendshape decomposition 120B (including its weights 120B-1, basis matrix 120B-2 and mean vector 120B-3) may be described herein as being a PCA decomposition (e.g. PCA decomposition 120B, PCA weights 120B-1, PCA basis matrix 120B-2 and PCA mean vector 120B-3). However, unless the context dictates otherwise, these elements should be understood to incorporate the process and outputs of other forms of matrix decomposition, dimensionality reduction techniques and/or geometry compression techniques.

As discussed above, animated facial geometry 110A may comprises a matrix A which includes the positions of a number vertices over a plurality of poses/frames (i.e. a plurality of different sets of 3D vertex positions). For example, animated facial geometry 110A may comprise a series of poses/frames (e.g. a poses/frames), where each pose/frame comprises 3D (e.g. {x, y, z}) position information for a set of n vertices. Accordingly, animated facial geometry 110A may be represented in the form of a matrix A (animated facial geometry A) of dimensionality [a, 3n]. As is known in the art of PCA matrix decomposition, the block 120 PCA decomposition may output a PCA mean vector 120B-2 (\vec{μ}), a PCA basis matrix 120B-3 (V) and a PCA weight matrix 120B-1 Z, which, together, provide PCA decomposition 120B.

PCA mean vector \vec{μ} may comprise a vector of dimensionality 3n, where n is the number of vertices 14 in the topology of a CG character's face mesh 12. Each element of PCA mean vector \vec{μ} may comprise the mean of a corresponding column of animated facial geometry A over the a poses/frames. PCA basis matrix V may comprise a matrix of dimensionality [k, 3n], where k is a number of blendshapes (also referred to as eigenvectors or principal components) used in the block 120 PCA decomposition, where k≤min(a, 3n). The parameter k may be a preconfigured and/or user-configurable parameter. The parameter k may be configurable by selecting the number k outright (i.e. parameter 122 of FIG. 3), by selecting a percentage of the variance (i.e. parameter 123 of FIG. 3) in animated facial geometry matrix A that should be explained by the k blendshapes and/or the like. In some currently preferred embodiments, the parameter k is determined by ascertaining a blendshape decomposition that has the variance to retain 99.9% of the animated facial geometry matrix A. Each of the k rows of PCA basis matrix V has 3n elements and may be referred to as a blendshape. PCA weights matrix Z may comprise a matrix of dimensionality [a, k]. Each row the matrix Z of PCA weights 23 is a set (vector) of k weights corresponding to a particular pose/frame of animated facial geometry matrix A.

The poses/frames of animated facial geometry matrix A can be approximately reconstructed from the PCA decomposition 120B according to Â=ZV+\vec{Ψ}, where Â is a matrix of dimensionality [a, 3n] in which each row of Â represents an approximate reconstruction of one pose/frame of input animated facial geometry matrix A and \vec{Ψ} is a matrix of dimensionality [a, 3n], where each row of \vec{Ψ} is the PCA mean vector \vec{μ}. An individual pose/frame of input animated facial geometry matrix A can be approximately constructed according to \hat{α}=\vec{z}V+\vec{μ}, where \hat{α} is the reconstructed pose/frame comprising a vector of dimension 3n, \vec{z} is the set (vector) of weights having dimension k selected as a row of PCA weight matrix Z. In this manner, a vector \vec{z} of weights (also referred to as blendshape weights) may be understood (together with the PCA basis matrix V and the PCA mean vector \vec{μ}) to represent a pose/frame of animated facial geometry 110A.

It will be appreciated that in some embodiments, PCA basis matrix 120B-3 may be constructed as a difference relative to the PCA neutral pose rather than as an absolute basis. In such cases, the poses/frames of animated facial geometry matrix A can be approximately reconstructed from the PCA decomposition 120B according to Â=Z*V* where Z* and V* are respectively relative weight and relative PCA basis matrices corresponding to this relative PCA decomposition. Similarly, in such cases, an individual pose/frame of input animated facial geometry matrix A can be approximately constructed according to \hat{α}=\hat{z}*V* where \hat{z}* is a vector of weights having dimension k corresponding to this relative PCA decomposition and to a row of relative PCA weight matrix Z.

In some embodiments, the step 120 process comprises determining the relative importance of some or all of the frames of animated facial geometry 110A and assigning weights to some or all of the frames based on their relative importance. In such embodiments, larger weights may be assigned to frames that contain expressions that are relatively rare or are otherwise considered to be relatively important. The weights may be utilized in the step 120 blendshape decomposition process to ensure that blendshape decomposition 120B can faithfully reproduce these relatively rare or otherwise important poses of animated facial geometry 110A with no or minimal error.

Referring back to FIG. 2 (on the right hand side of the illustrated view), method 100 comprises acquiring videos and/or images of an actor 20 having markers 22 applied on their face at step 130 to obtain footage 130A (also referred to as shot data 130A) of the actor 20 (with markers 22 applied on their face). Step 130 may comprise capturing a facial performance of the actor 20 (with markers 22 applied on their face) using a head-mounted camera (HMC) apparatus and/or the like to obtain footage 130A. In some example embodiments, step 130 may comprise recording video footage 130A of an actor 20 moving from a neutral expression to a first facial expression (e.g. a smiling expression) and back to the neutral expression. In some example embodiments, step 130 may comprise recording footage 130A of actor 20 performing any range of motions (e.g. his or her acting motions), as long as the range of motions includes an instance of a facial expression that relatively closely matches the facial expression of neutral face geometry 120A (e.g. a neutral expression). In some example embodiments, video footage 130A comprises a single shot/frame of actor 20 making a neutral expression. Video footage 130A may be recorded at a frame rate which is in the range of, for example, 30 frames per second (fps) to 120 fps (e.g. 45 fps, 60 fps, 75 fps, 90 fps, or 105 fps). Advantageously, method 100 does not require footage 130A to be recorded or otherwise acquired in high definition. For the purposes of facilitating the description, the step 130 process of acquiring videos and/or images of an actor 20 having markers 22 applied on their face (video footage 130A) may be referred to herein as acquiring shot data 130A and video footage 130A may itself be referred to as shot data 130A or marker data 130A.

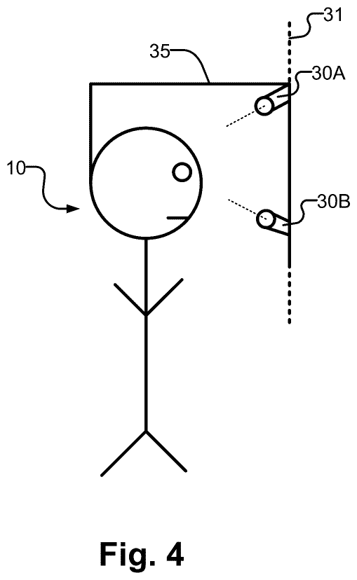

Step 130 comprises operating two or more cameras 30 positioned at different locations relative to the head of actor 20 (e.g. a HMC apparatus 35 typically includes an upper camera 30A and a lower camera 30B) to obtain two or more sets of footage 130A from two or more corresponding angles (e.g. see FIG. 4). Using the example HMV apparatus 35 shown in FIG. 4, step 130 may comprise operating two cameras 30A, 30B attached to a HMC apparatus 35 to capture images/videos of actor 20 to obtain two sets of synchronized footage 130A (i.e. sets of footage with temporal frame-wise correspondence, where each frame from camera 30A is captured at the same time as a corresponding frame from camera 30B) from two different angles. Each of the two or more cameras 30 may be positioned at any suitable angle relative to the position of the target (i.e. a face of an actor 20). The two or more cameras 30 may be configured to capture synchronized video/images of actor 20 with frame-wise temporal correspondence.

Step 130 also comprises obtaining calibration data 130B in addition to obtaining footage 130A. Calibration data 130B comprise data used for calibrating the image/videos captured by the cameras 30 positioned at different locations and for triangulating the 3D positions of markers 22. Calibration data 130B may include data corresponding to camera intrinsic parameters and/or data corresponding to camera extrinsic parameters. Examples of data corresponding to camera intrinsic parameters include, but are not limited to: data relating to the lens of the cameras (e.g. lens distortion), data relating to the focal length of the camera, data relating to the principal point, data relating to the model of the camera, data relating to the settings of the camera. Examples of data corresponding to camera extrinsic parameters include, but are not limited to: data relating to the relative angles of the cameras, the separation of the cameras and/or the like.

In the illustrative example shown in FIG. 4, HMC device 35 comprises a top camera 30A having its optical axis oriented downwards toward the face of actor 20 and a bottom camera 30B having its optical axis oriented upwards toward the face of actor 20 to capture images/videos of actor 10 and obtain footage 130A from two different angles. As explained in more detail below, the synchronized video/images 130A obtained from the two cameras 30A, 30B oriented at different angles may be used, together with calibration datat130B, to triangulate 2D marker positions obtained by the two cameras 30A, 30B to thereby obtain 3D reconstruction 140B (FIG. 2).

In some embodiments, obtaining calibration data 130B in step 130 comprises a first step of capturing a common grid displayed in front of cameras 30 attached to HMC 35, followed by a second step of using the captured grid to determine calibration data 130B (e.g. identify distortion caused by the respective lens of each of the cameras 30, determine data corresponding to camera extrinsic parameters, determine data corresponding to camera intrinsic parameters, etc.).

In some embodiments, obtaining calibration data 130B comprises extracting previously saved calibration data (e.g. data from another HMC 35) and processing or otherwise using the previously saved calibration data to obtain calibration data 130B. In some embodiments, some of calibration data 130B may be obtained by user input.

In some embodiments, calibration data 130B is obtained after acquiring the video footage and/or images of an actor 20 in step 130. In some embodiments, calibration data 130B is provided as an input (along with footage 130A) for the shot-data preparation step 140, as described in more detail below.

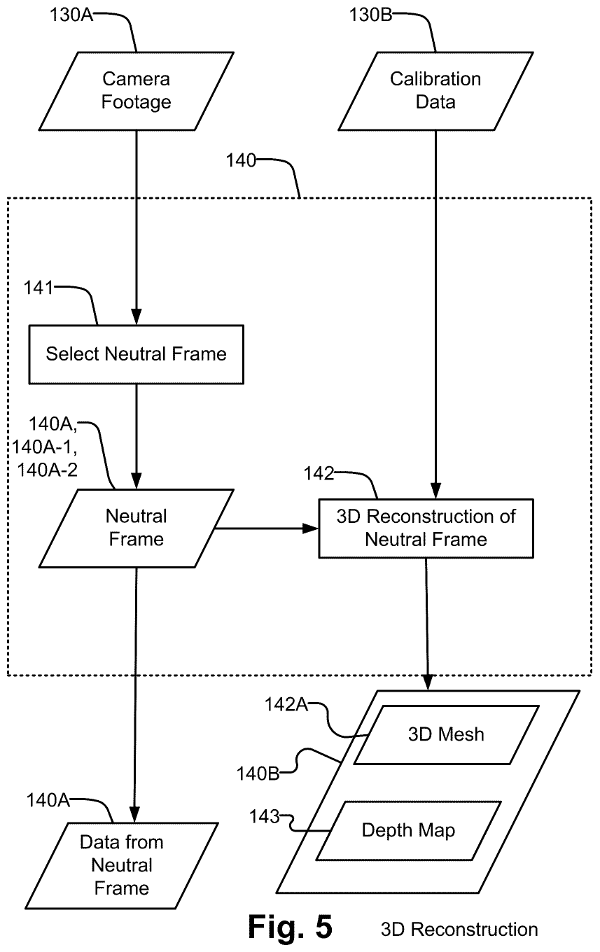

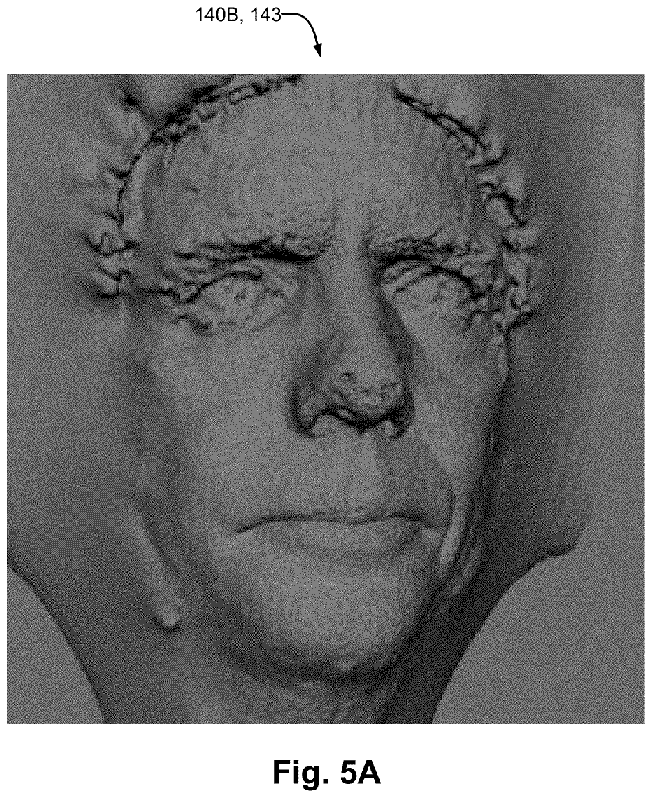

Referring back to FIG. 2, method 100 proceeds to step 140 after obtaining footage 130A of the face of actor 20 in step 130. Step 140 may comprise selecting a neutral frame 140A from footage 130A and generating one or more 3D reconstructions 140B of the face of actor 20 based on video footage 130A and calibration data 130B. In some embodiments, step 140 may comprise generating, and 3D reconstruction 140B may comprise, a 3D mesh 142A corresponding to the selected neutral frame 140A and/or a depth map 143 corresponding to the selected neutral frame 140A. FIG. 5A shows an example of 3D reconstruction 140B comprising a 3D mesh 142A corresponding to a selected neutral frame 140A created in 3D reconstruction step 140 from two sets of footage 130A. Depth map 143 may be generated using any suitable method (including, for example, triangulation) based on captured video data 130A corresponding to the selected neutral frame 140A captured from two or more cameras 30 together with calibration data 130B.

In embodiments where 3D reconstruction 140B includes a depth map 143, the depth map 143 may be stored as an image comprising pixels which have values (e.g. color values) that define the distance between the object (e.g. the face of actor 20) shown in neutral frame 140A and a suitably selected reference origin (that may be defined based on a mathematical representation of one the virtual camera from which the image was rendered).

FIG. 5 is a flowchart depicting an exemplary method 140 for obtaining 3D

reconstruction 140B of the face of actor 20 based on video footage 130A according to a particular embodiment. Method 140 comprises selecting a neutral frame 140A obtained contemporaneously from each set of video footage 130A (e.g. from each of the cameras 30 mounted on HMC device 35) in step 141. For example, method 140 may comprise selecting a neutral frame 140A captured contemporaneously by first camera 30A (e.g. a top camera) and by second camera 30B (e.g. a bottom camera). The data captured by first camera 30A (selected from corresponding video footage 130A-1) may provide a first set of data (or first image) 140A-1 and the synchronously captured data from second camera 30B (selected from corresponding video footage 130A-2) may provide a second set of data (or second image) 140A-2. The neutral frame 140A may be selected manually, with computer-assistance, or automatically.

After selecting the neutral frame 140A (e.g. to obtain corresponding first and second images 140A-1, 140A-2) from the neutral frame in step 141, method 140 proceeds to a 3D reconstruction step 142. 3D reconstruction step 142 may comprise generating, and 3D reconstruction 140B may comprise, a 3D mesh 142A corresponding to the selected neutral frame 140A and/or a depth map 143 corresponding to the selected neutral frame 140A.

3D reconstruction step 142 may comprise creating a 3D mesh 142A representing an object (e.g. a face of actor 20) based on images 140A-1, 140A-2 captured by two or more cameras corresponding to the selected neutral frame 140A. In some embodiments, reconstruction step 142 comprises creating a 3D mesh 142A based on data 140A from two or more cameras 30 (e.g. first image 140A-1 and second image 140A-2) and calibration data 130B. As described elsewhere herein, calibration data 130B may comprise data which is used in 3D reconstruction step 142 to perform a 3D reconstruction (e.g. a stereoscopic reconstruction) from image data obtained (e.g. images 140A-1, 140A-2) from two or more cameras 30. Calibration data 130B may also include data which compensates or otherwise accounts for differences in cameras 30 and/or their images such as, by way of non-limiting example, lens distortion and/or the like. In some embodiments, the output of step 142 (i.e. 3D reconstruction 140B) comprises a 3D mesh 142A corresponding to the selected neutral frame 140A. FIG. 5A is a rendering of an exemplary 3D mesh 142A.

In some embodiments, 3D reconstruction step 142 may additionally or alternatively comprise generating a depth map 143 based on the images 140A-1, 140A-2 captured by two or more cameras corresponding to the selected neutral frame 140A. In some embodiments, reconstruction step 142 comprises creating depth map 143 based on images of a neutral frame 140A from two or more cameras 30 (e.g. first image 140A-1 from camera 30A corresponding to the selected neutral frame 140A and a second image 140A-2 from camera 30B corresponding to the selected neutral frame 140A) and calibration data 130B. Creating a depth map 143 in 3D reconstruction step 142 may comprise stereoscopic reconstruction. In some embodiments, 3D reconstruction step 142 comprises rendering (i.e.

generating an image corresponding to) 3D mesh 142A to obtain a depth map 143 corresponding to selected neutral frame 140A. The depth map 143 may be rendered from the perspective of a notional camera as defined in calibration data 130B. Different depth maps 143 may be rendered from the perspective of different cameras, so that there is sufficient coverage of the volume of the face from the different perspectives of the different available cameras. As described elsewhere herein, depth map 143 may be stored as an image comprising pixels which have values (e.g. color values) that define distances between the point on the face visible at that given pixel and some suitably selected origin. In some embodiments, depth map 143 stores values which define, for each pixel, a distance (i.e. depth) between a point on the face and a corresponding point located on a notional plane 31 which may contain the origin of the camera used for rendering (e.g. see FIG. 4). In some embodiments, 3D reconstruction data 140B comprises one or more depth maps 143.

Referring back to FIG. 2, after generating 3D reconstruction data 140B (which may include a 3D mesh 142 and/or a depth map 143 corresponding to the selected neutral frame 140A), method 100 proceeds to a non-rigid registration step 150. Non-rigid registration step 150 involves determining a solved face geometry 150A based on animated face geometry 110A, neutral face geometry 120A, blend shape decomposition 120B, and 3D reconstruction 140B. As explained in more detail below, in embodiments where 3D reconstruction data 140B comprises a 3D mesh (e.g. 3D mesh 142A), step 150 may comprise performing ray-casting queries on the 3D mesh 142A to identify the intersecting points from ray(s) directed from the camera through a corresponding vertex of solved face geometry 150A onto the 3D mesh and determining the depth that such rays intersect the mesh. Solved face geometry 150A may comprise: translation parameters 150A-3, rotation parameters 150A-2 and a set of output blendshape weights 150A-1 (i.e. a weight for each blendshape in blendshape decomposition 120B). In some embodiments, translation parameters 150A-3 may comprise a translation matrix 150A-3, which may parameterize an x-offset, y-offset, and z-offset) or other form of translational transformation. In some embodiments, rotation parameters 150A-2 may comprise a rotation matrix 150A-2 which may parameterize various forms of rotational transformations.

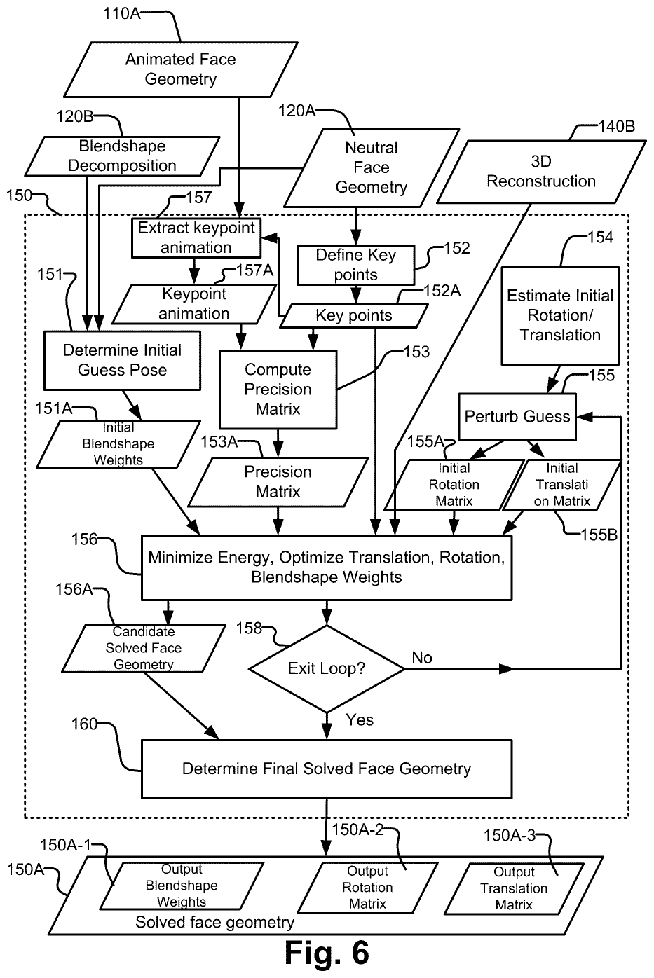

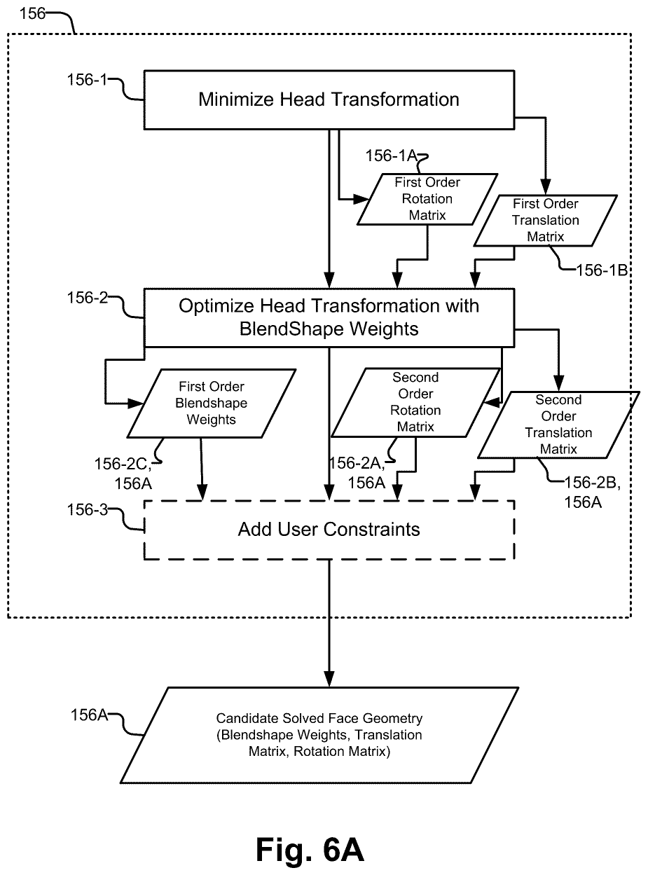

FIG. 6 is a flowchart depicting an exemplary method 150 of non-rigid registration according to a particular embodiment. Method 150 begins at step 151 which comprises determining an initial guess pose of animated face geometry 110A to be used by a suitably configured solver as an guess that will approximate 3D reconstructions 140B (e.g. 3D mesh 142A and/or depth map 143). As discussed above, a blendshape decomposition (or some other suitable form of compression) is performed in step 120 on animated geometry 110A. Accordingly, step 151 may comprise selecting the compressed representation of neutral face geometry 120A as an initial guess that will approximate 3D reconstruction 140B. In the illustrated embodiment, where the block 120 compression is a PCA decomposition, step 151 may comprise determining the PCA blendshape weights (e.g. PCA blendshape weights 120B-1 shown in FIG. 3) corresponding to neutral face geometry 120A (see FIG. 2) to thereby obtain an initial guess for blendshape weights 151A corresponding to the block 120 blendshape decomposition that will approximate 3D reconstruction 140B. As discussed above in connection with PCA decomposition 120B, this initial guess for blendshape weights 151A may comprises a set of weights in the form of a vector \vec{z} of weights having dimension k, where k is the number of blendshapes in PCA blendshape decomposition 120B (or a vector \vec{z}* of weights having dimension k in the case of a relative PCA decomposition).

After or in parallel with determining the initial guess for blendshape weights 151A in step 151, method 150 comprises building an animation prior that may be used as a regularization to constrain the set of solutions (i.e. available solutions of the step 156 optimization/solver process) to limit the set of solutions to realistic solved face geometries that are similar to, or consistent with, animated face geometry 110A.

In some embodiments, method 150 comprises step 152 which involves defining some vertices on neutral face geometry 120A as key points 152A or otherwise defining some vertices in the topology of animated face geometry 110A to be key points 152A. Key points 152A may be determined by artists or by automated methods like mesh decimation or the like. In some embodiments, key points 152A may be defined at locations corresponding to (or close to) those expected to have markers 13 registered thereon. In some embodiments, key points 152A may be relatively more concentrated at locations that are likely to exhibit more geometric change with changing facial expression and are relatively less concentrated at locations that are likely to exhibit less geometric change with changing facial expression. Once key points 152A are defined in block 152, the animation of key points 152A may be extracted from animated face geometry 110A in block 157 to obtain key point animation 157A. This step 157 key point extraction process may comprise determining, and key point animation 157A may comprise, the locations of key points 152A at each pose/frame of animated face geometry 110A.

After defining key points 152A and extracting key point animation 157A, method 150 proceeds to block 153 which comprises computing a precision matrix 153A based on animated face geometry 110A (or, in some embodiments, based on key point animation 157A). As discussed above, animated face geometry 110A may be represented in the form of a matrix A of shape [a, b], where a is the number of frames and b is the number of features (typically, b/3 is the number of vertices). In general, a precision matrix on an input matrix is the inverse of the covariance matrix of the input matrix. As such, precision matrix 153A may comprise the inverse of the covariance matrix of animated face geometry 110A. To reduce computation time and/or computational complexity, step 153 may, in some embodiments, comprise computing precision matrix 153A to be the inverse of the covariance matrix of key point animation 157A. The covariance matrix of key point animation 157A may have the shape [3p, 3p], where p is the number of key points 152A defined in step 152. It will be appreciated that the covariance matrix is reflective of how each vertex coordinate (e.g. x, y, z coordinates) of animated face geometry 110A (or key point animation 157A) moves in relation to the coordinates of other vertices, with the diagonal elements of the covariance matrix equal to 1 (i.e. since each feature has 100% correlation with itself).

In some embodiments, method 150 may optionally comprise a step 154 for estimating an initial head translation and/or initial head rotation of actor 20 to account for the head translation and/or rotation of actor 20 as part of the process of solving the initial guess pose (as represented by initial blendshape weights 151A) to 3D reconstruction 142 in step 156. The initial head translation and initial rotation of actor 20 may be expressed as a corresponding pair of matrices or other suitable translation parameters and/or rotation parameters. In some embodiments, the elements of the translation and/or rotation matrices may be estimated or otherwise provided by a user (e.g. an artist). In some embodiments, the initial head translation and/or initial rotation may be randomly generated. In some embodiments, the initial head translation and/or initial rotation of actor 20 may be expressed as the identity matrix (i.e. corresponding to a lack of translation and rotation).

After estimating the initial head translation and/or initial head rotation of actor 20 in step 154, method 150 comprises perturbing the initial estimate (e.g. with noise) at step 155 to obtain initial rotation matrix 155A and initial translation matrix 155B. In some embodiments, step 155 comprises perturbing the initial block 154 translation matrix with uniform noise to obtain initial translation matrix 155B. In some such embodiments, the user may specify a range of translation noise (or such a range may be hard-coded) and the uniform noise applied to the initial block 154 translation matrix may be selected (e.g. randomly) from the range of available translation noise and this perturbation may be applied in block 155 to obtain initial translation matrix 155B. In some embodiments, step 155 additionally or alternatively comprises perturbing the initial block 154 rotation matrix with uniform noise to obtain initial rotation matrix 155A. In some such embodiments, the user may specify a range of rotation noise (or such a range may be hard-coded) and the uniform noise applied to the initial block 154 rotation matrix may be selected (e.g. randomly) from the range of available rotation noise and this perturbation may be applied in block 155 to obtain initial rotation matrix 155A. The output of the block 155 perturbation process may comprise an initial estimate of a rotation matrix (or other rotation parameters) 155A and an initial estimate of a translation matrix (or other translation parameters) 155B that may be provided as input to the step 156 solver.

After completing some or all of steps 151, 152, 153, 154, 155 and 157, method 150 proceeds to step 156. Step 156 involves implementing a computer-based optimization/solver process which comprises minimizing an energy function by optimizing one or more parameters (e.g. head translation parameter(s), head rotation parameter(s) and/or blendshape weights) to obtain optimized values for these parameters (e.g. optimized head translation parameter(s) 150A-3, optimized head rotation parameter(s) 150A-2 and/or optimized blendshape weights 150A-1), which together can be used to reconstruct the geometry (volume) of the 3D reconstruction 140B corresponding to neutral frame 140A which is generated from video footage (shot data) 130A of the actor 20. Together, the optimized values of these parameters may be referred to herein as a candidate solved face geometry 156A. In the illustrated embodiment of FIG. 6, the step 156 solver receives a number of inputs comprising initial blendshape weights 151A (corresponding to the initial guess pose, which may correspond to neutral face geometry 120A), 3D reconstruction 140B, key points 152A, precision matrix 153A (typically, the precision matrix corresponding to key point animation 157A), an initial estimate of rotation parameters (e.g. an initial estimate of a rotation matrix) 155A and an initial estimate of translation parameters 155B (e.g. an initial estimate of a translation matrix 155B). In the description that follows, input rotational parameters 155A and input translational parameters 155B may be referred to as rotational matrix 155A and translational matrix 155B without loss of generality.

In the illustrated embodiment of FIG. 6, each candidate solved face geometry 156A output from block 156 (and the ultimate solved face geometry 150A output from method 150) comprises: a set of output translation parameters 150A-3 (e.g. an output translation matrix 150A-3) which may parameterize an x-offset, y-offset, and z-offset or some other form of translational transformation; a set of output rotation parameters 150A-2 (e.g. an output rotation matrix 150A-2) which may parameterize a rotational transformation in various formats; and a set of output blendshape weights (e.g. blendshape weights 150A-1) which may comprise a weight for each blendshape in blendshape decomposition 120B. In the description that follows, output rotational parameters 150A-2 and output translational parameters 150A-3 may be referred to as output rotational matrix 150A-2 and output translational matrix 150A-3 without loss of generality. The block 156 energy function may comprise a first term comprising a difference metric between: a blendshape reconstruction parameterized by a set of blendshape weights corresponding to the blendshape basis (e.g. PCA blendshape basis 120B-3) of blendshape decomposition 120B; and 3D reconstruction 140B. The block 156 energy function may comprise a second term representative of the “likelihood” of a particular pose (explained in greater detail below). The block 156 energy function may comprise a third term that accounts for additional user-specified constraints, weights or metrics. For example, such a block 156 energy function may have a form:

$$E ( pose ) = {w}_{1} ( GeoToDepthDistance ( geo ( pose , transform ) ) + {w}_{2} ( negativeLogLikelihood ( keypoints ( pose ) ) + w 3 ( usercontraints ( geo ( pose , transform ) ) \qquad ( 1 )$$

where: pose comprises: a set of blendshape weights corresponding to the blendshape basis (e.g. PCA blendshape basis 120B-3); and, where applicable, a blendshape mean vector (e.g. PCA mean vector 120B-2) of blendshape decomposition 120B; transform comprises a set of rotational parameters (e.g. a rotation matrix) and a set of translational parameters (e.g. a translation matrix). It will be appreciated from the description herein that the parameters of pose and transform represent the variables being optimized (solved for) in the block 160 solver to yield candidate blendshape weights 150A-1 (pose parameters), and candidate rotation and translation matrices 150A-2, 150A-3 (transform parameters) associated with candidate face geometry 150A. Returning to equation (1), geo(·,·) reconstructs a high-resolution facial geometry from the blendshape weights specified by the pose parameters using the blendshape basis (e.g. PCA blendshape basis 120B-3) and, optionally, the blendshape mean vector (e.g. PCA mean vector 120B-2) as described above and then translates and rotates the facial geometry using (e.g. by matrix multiplication) the translation and rotation parameters specified by the transform parameters; keypoints(·) reconstructs a key point facial geometry from the blendshape weights using elements of the blendshape basis and, optionally, the blendshape neutral vector for a subset (the key points 152A) of the vertices extracted from the pose parameters; and w₁, w₂, w₃ are configurable (e.g. user-configurable) weights for the various terms of the block 156 equation (1) energy function. It will be appreciated that performing the keypoints(·) function, block 156 may comprise extracting blendshape weights corresponding to key points 152A from the set of blendshape weights defined by pose and may use elements of the blendshape basis corresponding to key points 152A.

In the description of the block 156 optimization process, the translated and rotated reconstructed high-resolution face geometry output by the geo(·,·) function may be referred to as the “reconstructed high-resolution geometry” for brevity. Similarly, in the description of the block 156 optimization process, the reconstructed key point face geometry output by the keypoints(·) may be referred to as the “reconstructed key point geometry” for brevity.

The Geo ToDepthDistance(·) function in the first term of the equation (1) block 156 energy function may determine a distance metric (e.g. a depth) between the reconstructed high-resolution face geometry (reconstructed using the geo(·,·) function) and 3D reconstruction 140B. In some embodiments, the GeoToDepthDistance(·) function converts the vertex positions of the reconstructed high-resolution face geometry into 2D coordinates using the definition of the notional camera defined in camera calibration data 130B (or, in some embodiments, the definitions of more than one notional camera, where more than 2 cameras 30 are used to capture shot data 130A). The Geo ToDepthDistance(·) function may involve querying 3D reconstruction 140B at non-integer pixel coordinates using interpolation (e.g. bilinear interpolation). The GeoToDepthDistance(·) function may, in some cases, ignore and/or provide different weights to some vertices of the reconstructed high resolution face geometry. For example, 3D reconstruction 140B may exhibit spurious data for some pixels (see, for example, the edges of the face in the exemplary 3D mesh 142A of FIG. 5A). In some embodiments, a binary (or weighted) mask may be used to select (or weight) particular vertices of the reconstructed high resolution face geometry for use in the GeoToDepthDistance(·) to mitigate the effect of regions where 3D facial reconstruction 140B may exhibit spurious data or regions where a confidence in 3D facial reconstruction 140B may be relatively high or relatively low. Such a mask can be generated using any suitable technique, including, for example, user input or automated segmentation techniques.

In some embodiments, the Geo ToDepthDistance(·) function has a form:

$$GeoToDepthDistance ( vertexPositions ) = sum ( robustNorm ( ( ( vertexDepths ( vertexPositions ) \backslash [ NoBreak ] - return Z ( vertexPositions ) ) * weightedMask ) ) \qquad ( 2 )$$

Where: vertexPositions represents the 3D vertex positions of the reconstructed high-resolution face geometry (reconstructed using the geo(·,·) function); sum(·) is the summation function; robustNorm(·) is a robust norm function that calculates a robust norm for each of its inputs and returns a corresponding array of robust norms, which, in some embodiments, may be implemented using a pseudo-Huber loss function with a user-configurable parameter Δ that defines when to switch between L1 and L2 norms; weightedMask is the binary (or weighted) vertex mask discussed above, which is applied (e.g. multiplied) for each vertex to the difference of ((vertexDepths(vertexPositions)−returnZ (vertexPositions)); returnZ(·) is a function that returns a vector that stores the z-coordinates of the vertices of the reconstructed high-resolution face geometry as represented in camera space; vertexDepths(·) is a function that queries 3D reconstruction 140B at pixel coordinates corresponding to vertexPositions of the reconstructed high-resolution face geometry to return a vector representative of the depths of 3D reconstruction 140B at the queried pixel coordinates. In some embodiments, the vertexDepths(·) function has the form:

$$vertexDepths ( vertexPositions ) = bilinearQuery ( ( vertexPixels ( vertexPositions ) , depthMap ) ) \qquad ( 3 )$$

where: depthMap is 3D reconstruction 140B, vertexPixels(·) is a function that returns, for each vertex in vertexPositions, a vector storing two coordinates corresponding to the projected pixel coordinates (e.g. (x, y)) in image space using a camera projection matrix (the parameters of which may be contained in calibration data 130B), and bilinearQuery(·) is a function that, for each vertex in vertexPositions, uses bilinear interpolation to query values of 3D reconstruction 140B at a location corresponding to the two projected pixel coordinates output from vertexPixels(·).

In embodiments where 3D reconstruction data 140B comprises a 3D mesh (e.g. 3D mesh 142A), the vertexDepths(·) function may comprise performing ray-casting queries on the 3D mesh of 3D reconstruction data 140B to identify the intersecting points (on the 3D mesh of 3D reconstruction data 140B) from ray(s) directed from a suitably selected reference origin that may be based on one or more cameras used capture video footage 130A through vertices of the reconstructed high-resolution geometry 150A (e.g. output from the geo(·,·) function).

Referring back to the energy function of equation (1), the second term of energy function (1) includes a configurable weight constant w₂, a keypoints(·) function that converts the pose inputs to a reconstructed key point geometry comprising only key points 152A (e.g. by dropping the columns storing the features of the “non-key points” from the PCA blendshape decomposition 120B), and a negativeLogLikelihood(·) function which may be used as an animation prior to provide energy function (1) with a term based on a “likelihood” of potential candidate poses when compared to animated face geometry 110A. In some embodiments, the negativeLogLikelihood(·) function has the form:

$$negativeLogLikelihood ( keypoints ) = {[ keypoints - {μ}_{KeypointPositions} ]}^{T} \cdot [ P ] \cdot [ keypoints - {μ}_{KeypointPositions} ] \qquad ( 4 )$$

where: keypoints is a vector storing the 3D positions of the vertices (3 coordinates for each vertex) corresponding to key points 152A (i.e. the output of the keypoints(·) function), also referred to herein as the reconstructed key point geometry, μ_{KeypointPositions} is a vector storing the mean 3D positions of the vertices corresponding to key points 152A (3 coordinates for each vertex) across the frames of animated face geometry 110A, and P is the precision matrix 153A (corresponding to key point animation 157A) determined at step 153.

Referring back to the energy function of equation (1), the third term of energy function (1) includes a weight constant w₃, and a userconstraints(·) function that can optionally be used to customize energy function (1) by adding hard or soft user constraints to energy function (1). By way of non-limiting example, a user could provide 2D position constraints, where the user specifies the coordinate of particular vertices through (or relative to) the camera or 3D position constraints, where the user specifies the 3D locations of particular vertices. In some embodiments, the userconstraints(·) function could use the L2 norm (or some other suitable metric) to compute a Euclidean distance between: the 3D position of a vertex (or its corresponding 2D coordinates in image space) as specified by reconstructed high-resolution geometry (e.g. output from the geo(·,·) function); and the user's specified position and then sum the L2 norms computed in this manner over all of the user-specified positions.

FIG. 6A is a flowchart depicting an exemplary method 156 of adjusting the blend shape weights of input blendshape weights 151A, the translation parameter(s) (e.g. of input translation matrix) 155B, and the rotation parameter(s) (e.g. of input rotation matrix 155A) to minimize a corresponding energy function (e.g. the energy function of equation (1)) and to thereby generate a candidate solved face geometry 156A. As discussed above, a candidate face geometry 156A comprises: output translation parameters (e.g. an output translation matrix); output rotational parameters (e.g. an output rotation matrix); and a set of output blendshape weights which may comprise a weight for each blendshape in blendshape decomposition 120B.

In the example embodiment illustrated in FIG. 6A, method 156 begins at step 156-1. Step 156-1 comprises minimizing an energy function (e.g. the energy function of equation (1)) by adjusting the rotation parameter(s) 155A and the translation parameter(s) 155B (while keeping the input blendshape weights 151A constant). This step 156-1 optimization (energy function minimization) may use any suitable optimization/solver technique. Non-limiting examples of suitable methods include the conjugate gradient method, the dogleg method, the Powell method and/or the like. The output of step 156-1 are first order optimized rotation and translation parameters 156-1A, 156-1B, which may be used as inputs to step 156-2. Method 156 then proceeds to step 156-2 which comprises minimizing an energy function (e.g. the energy function of equation (1)) by adjusting the rotation parameter(s) of first order optimized rotation parameters 156-1A, the translation parameter(s) of first order optimized translation parameters 156-1B and the input blendshape weights 151A. By keeping the blendshape weights constant in step 156-1 and then introducing the blendshape weights as optimization parameters in block 156-2, the likelihood of spurious results caused by local minima associated with optimizing the blendshape weights may be mitigated. For example, in this application, the optimized blendshape weights are expected to be relatively close to those associated with the neutral face expression and, consequently, it may be desirable to adjust the translation and rotation first to roughly align to 3D reconstruction 140B prior to varying the blendshape weights to account for facial expression. The step 156-2 optimization (energy function minimization) may use the same optimization/solver technique as step 156-1, although this is not necessary, and, in some embodiments, the step 156-2 optimization may use a different optimization technique than the step 156-1 optimization. The output of step 156-2 comprises second order optimized rotation and translation parameters (e.g. matrices 156-2A, 156-2B) and first order optimized blendshape weights 156-2C. Second order optimized rotation and translation parameters 156-2A, 156-2B and first order optimized blendshape weights 156-2C may be used as inputs to optional step 156-3. Where optional step 156-3 is not used, then second order optimized rotation and translation parameters 156-2A, 156-2B and first order optimized blendshape weights 156-2C may be used as the output of the block 156 optimization-i.e. as candidate solved face geometry 156A (see FIG. 6). Optional step 156-3 (where it is used) may comprise minimizing an energy function (e.g. the energy function of equation (1) or the energy function of equation (1) with additional user-imposed terms) by adjusting the rotation parameter(s) of second order optimized rotation parameters 156-2A, the translation parameter(s) of second order optimized translation parameters 156-2B and first order optimized blendshape weights 156-2C. The output of optional step 156-3 (where used) comprises candidate solved face geometry 156A, which includes: optimized rotation and translation matrices and optimized blendshape weights.

Returning to FIG. 6, after generating a candidate solved face geometry 156A in step 156, method 150 proceeds to step 158. Step 158 comprises determining whether optimization step 156 has been performed a sufficient number of times to generate a sufficient number of candidate solved face geometries 156A. The number of candidate solved face geometries for the block 158 evaluation may comprise a configurable (e.g. user-configurable) parameter of method 150. In some embodiments, step 158 is implemented by using a FOR-LOOP or the like. If the step 158 evaluation determines that more candidate solved face geometries are required, then, method 150 proceeds back to step 155 where the initial block 154 head translation and/or rotation parameters of actor 20 are perturbed with a different perturbation (e.g. a different translation and/or rotation noise) to generate new initial rotation and translation parameters 155A, 155B before performing the step 156 optimization again to generate another candidate solved face geometry 156A. If the step 158 evaluation determines that a sufficient number candidate solved face geometries 156A have been generated, then method 150 proceeds to step 160.

Step 160 comprises determining a final solved face geometry 150A based on the

input candidate solved face geometries 156A generated in step 156. Final saved geometry 150A may comprise: output blendshape weights 150A-1, output rotation parameters (e.g. output rotation matrix) 150A-2 and output translation parameters (e.g. output translation matrix) 150A-3. In some embodiments, step 160 comprises selecting the candidate face geometry 156A with the lowest error (e.g. the lowest step 156 energy function evaluation). In some embodiments, step 160 comprises determining output blendshape weights 150A-1, output rotation parameters 150A-2 and output translation parameters 150A-3 to be the averages of all (or a subset of) the candidate blendshape weights, candidate rotation parameters and candidate translation parameters from among candidate solved face geometries 156A. It will be appreciated that solved face geometry 150A is a representation of a high-resolution 3D mesh (e.g. when output blendshape weights 150A-1 are used to reconstruct a 3D geometry and then rotated and translated using output rotation and translation parameters 150A-2, 150A-3 (e.g. by multiplication with output rotation matrix 150A-2 and translation matrix 150A-3) and that the 3D mesh represented by solved face geometry 150A will have a head orientation and facial expression that matches those of 3D reconstruction 140B.

Referring back to FIG. 2, after generating solved face geometry 150A in step 150, method 100 proceeds to step 170 which involves marker registration. It will be appreciated from above, that solved face geometry 150A provides a match to the geometry (e.g. volume) of the actor's face as captured in shot data 130A and as reflected in 3D reconstruction 140B, but to this stage of method 100, method 100 has not made use of markers 22 that are captured in shot data 130A. Marker registration step 170 comprises registering markers 22 applied on the face of actor 20 (and recorded in footage 130A) onto corresponding locations on solved face geometry 150A and, optionally, on neutral face geometry 120A. That is, step 170 comprises establishing a mapping between each of the markers 22 applied on the face of actor 20 and a corresponding point on solved face geometry 150A, and optionally, to a corresponding point on neutral face geometry 120A. The mapping between each of the markers 22 applied on the face of actor 20 and a corresponding point on solved face geometry 150A may be referred to herein as marker registration data 173A or day-specific marker registration 173A. The optional mapping between each of the markers 22 applied on the face of actor 20 and a corresponding point on neutral face geometry 120A may be referred to herein as the day-specific marker neutral 170A.

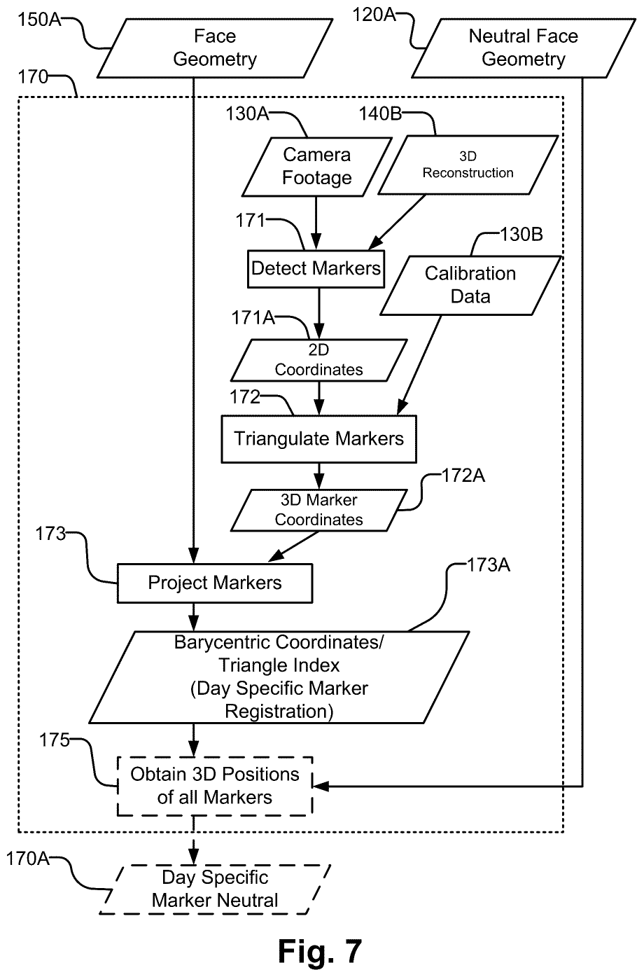

FIG. 7 is a flowchart depicting an exemplary method 170 of registering markers 22 on solved face geometry 150A and, optionally, on neutral face geometry 120A according to a particular embodiment. Method 170 begins with identifying the positions of markers 22 in a neutral frame (e.g. neutral frame 140A (see FIG. 5)) of each footage 130A (e.g. footage 130A from each camera 30 of HMC) at step 171 to obtain 2D pixel coordinates 171A for each marker 22 in the neutral frame 140A of footage 130A corresponding to each camera 30. In some embodiments, step 171 is performed manually (e.g. by an artist finding markers 22 on the neutral frame 140A of footage 130A corresponding to each camera 30 and identifying corresponding 2D coordinates 171A). In some embodiments, step 171 is performed partially automatically (e.g. using a suitable “blob detection” technique, such as the blob detection algorithm from the OpenCV project (available at https://docs.opencv.org/3.4/d0/d7a/classcv_1_1SimpleBlobDetector.html), the blob detection algorithm from https://scikit-image.org/docs/dev/auto_examples/features_detection/plot_blob.html and/or the like. These techniques detect blobs which then may be assigned labels (e.g. by a user). Where a marker 22 corresponds to more than one pixel (e.g. 10 pixels), step 171 may involve identifying or otherwise determining a pixel representing the center of marker 22 and using the identified center pixel as the point for projecting markers 22 onto solved face geometry 150A (as explained in more detail below). In some embodiments, step 171 comprises identifying the positions of markers 22 in the neutral frame 140A of footage 130A obtained from two or more cameras 30. In these embodiments, step 171 may optionally comprise determining the positions of markers 22 in the neutral frame 140A of footage 130A corresponding to each camera 30 in view of calibration data 130B.

After obtaining 2D pixel coordinates 171A corresponding to each marker 22, method 170 proceeds to step 172. Step 172 comprises triangulating the identified 2D pixel coordinates 171A using camera calibration data 130B to obtain 3D coordinates 172A for each marker 22. The 3D coordinates 172A of markers 22 are then projected onto solved face geometry 150A in step 173 to obtain the coordinates 173A of the markers 22 on solved face geometry 150A. As discussed above, solved face geometry 150A is a representation of a 3D mesh comprising triangles (or other polygons) defined between triplets of corresponding vertices (or different numbers of vertices for polygons other than triangles). As such, the coordinates 173A obtained in block 173 (which represent the projection of 3D marker coordinates 172A onto solved face geometry 150A) may comprise, for each marker 22 in footage 130A: a triangle identifier (e.g. an index of a triangle within the mesh of solved face geometry 150A); and corresponding barycentric coordinates which identify the location of the projection in the corresponding triangle. Where the mesh of solved face geometry 150A is made up of polygons other than triangles, then coordinates 173A may comprise for each marker 22: a polygon identifier; and a set of generalized barycentric coordinates which identify the location of the projection in the corresponding polygon.

Step 173 may be performed or otherwise implemented in several different ways. In some embodiments, step 173 comprises ray tracing the markers 22 onto solved face geometry 150A by, for example, taking the origin of the notional camera, tracing a ray that passes through the center of 3D coordinates 172A corresponding to a marker 22, and determining the location where the ray lands on solved face geometry 150A. In some embodiments, step 173 comprises performing a 3D closest-point query to identify the triangle and location (barycentric coordinates) within solved face geometry 150A that is closest to 3D coordinates 172A of marker 22.

The output of block 173 is, for each marker 22 applied to the face of actor 20 and captured in shot data 130A, a corresponding triangle ID and barycentric coordinates (together, marker registration data 173A) for the location of that marker on solved face geometry 150A. With this marker registration data 173A, the polygonal 3D mesh 12 of a CG character can be animated or otherwise driven using markers 22 captured from the performance of an actor 20 (i.e. the shape of 3D face mesh 12 can be deformed based on movements of markers 22).

After obtaining coordinates (barycentric coordinates and triangular index) 173A of the markers 22 on solved face geometry 150A in step 173, method 170 may optionally comprise querying neutral face geometry 120A at coordinates 173A of solved face geometry 150A in step 175 to obtain the 3D positions of markers 22 on neutral face geometry 120A. Step 175 is optional and can be used in some embodiments to assist with process flow.

In some embodiments, neutral face geometry 120A is represented as a matrix V of shape [v, 3], where v is the number of vertices of neutral face geometry 120A. Each row of matrix V corresponds to a vertex and each column of matrix V corresponds to a coordinate (e.g. x, y, z coordinates) of the vertex. In such embodiments, the topology of neutral face geometry 120A may be specified by a matrix T of shape [t, 3], where tis the number of triangles of neutral face geometry 120A. Each row of matrix T corresponds to a triangle and each column corresponds to a vertex of matrix V. In such embodiments, step 175 may comprise obtaining the vertex indices for a triangle, followed by obtaining the vertex positions of the vertex indices, followed by computing the 3D positions of markers 22 on neutral face geometry 120A. The 3D positions of markers 22 on neutral face geometry 120A may be computed as follows:

$${\vec{Pos}}_{k} = {c}_{1} ( {\vec{V}}_{1 k} ) + {c}_{2} ( {\vec{V}}_{2 k} ) + {c}_{3} ( {\vec{V}}_{3 k} ) \qquad ( 6 )$$

Where: k is the index of a particular triangle (from coordinates 173A) corresponding to a particular marker 22, (c₁, c₂, c₃) are the barycentric coordinates of a marker 22 (from coordinates 173A), and [symbol] are the positions of the vertices that define the k^{th} triangle of neutral face geometry 120A. Equation (6) related to triangles having 3 vertices. Where the 3D mesh comprises polygons having N vertices, then equation (6) generalizes to:

$${\vec{Pos}}_{k} = {\sum }_{i = 1}^{N} {c}_{i} ( {\vec{V}}_{ik} ) \qquad ( 6 A )$$

where: k is the polygon identifier of the particular polygon of the 3D mesh onto which the marker is projected; N is the number of vertices that define the polygon, (c₁, c₂, . . . c_{N}) are the set of parameters which defines wherein the particular polygon the marker is projected; and [symbol] are locations of the vertices that define the kth polygon of the neutral configuration of the 3D mesh.

The output of step 175, referred to herein as day-specific marker neutral 170A, comprises 3D positions ( [symbol] ) of each marker 22 on neutral face geometry 120A. Markers 22 are registered on neutral face geometry 120A upon completion of step 175 in method 170.Day-specific marker neutral 170A and day-specific marker registration 173A may be referred to as day-specific, because each day that actor 20 goes to the recording set, the markers may be painted on his or her face in different locations. So each time that marker registration is performed in block 170 to obtain day-specific marker registration 173A and/or day-specific marker neutral 170A, day-specific marker registration 173A provides a location for these markers on solved face geometry 150A (i.e. registers the markers to the solved face geometry 150A) and day-specific marker neutral 170A provides a location for these markers on the neutral mesh (i.e. registers the markers to the neutral mesh).

Method 100 may include a wide range of variations and/or supplementary features. These variations and/or supplementary features may be applied to all of the embodiments of method 100 and/or the steps thereof described above, as suited, and include, without limitation:
method 100 may be performed with actor 20 making any “designated” expression to register markers 22 applied on the face of actor 20 to corresponding points 13 on face geometry 10 (i.e. actor 20 does not need to make a neutral expression and can make any “designated” expression as long as face geometry 10, 120A is modelled based on the same designated expression);

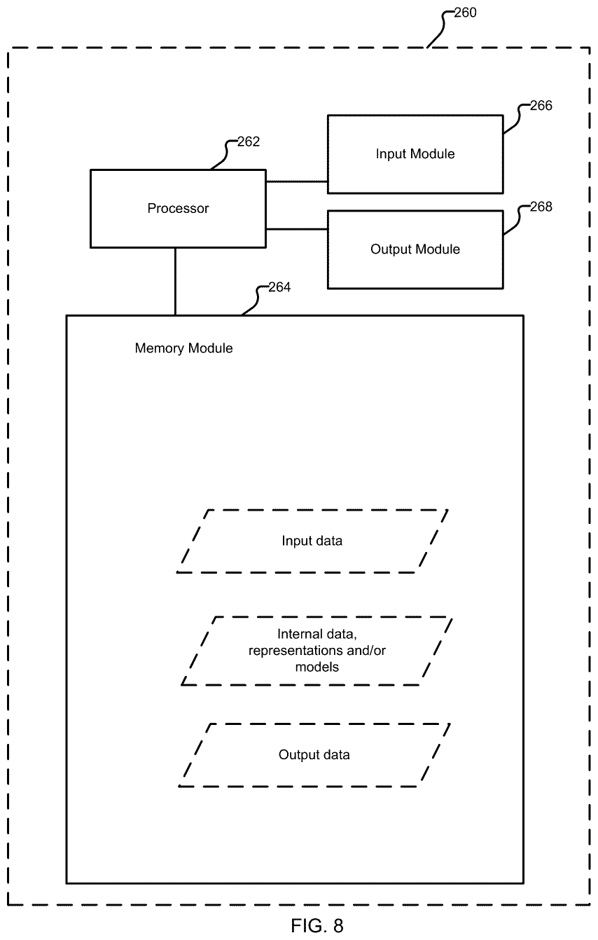

Some aspects of the invention provide a system 260 (an example embodiment of which is shown in FIG. 8) for performing one or more of the methods described herein (e.g. the methods FIGS. 2, 3, 5, 6, 6A and 7 and/or portions thereof). System 260 may comprise a processor 262, a memory module 264, an input module 266, and an output module 268. Memory module 264 may store any of the models, data and/or representations described herein-e.g. those shown in parallelogram-shaped boxes in other drawings. Processor 262 may receive (via input module 266) any inputs to any of the methods described herein and may store these inputs in memory module 264. Processor 262 may perform any of the methods described herein (and/or portions thereof). Processor 262 may output (via output module 268) any of the data and/or outputs of any of the methods described herein

Where a component is referred to above, unless otherwise indicated, reference to that component (including a reference to a “means”) should be interpreted as including as equivalents of that component any component which performs the function of the described component (i.e. that is functionally equivalent), including components which are not structurally equivalent to the disclosed structure which performs the function in the illustrated exemplary embodiments of the invention.

Unless the context clearly requires otherwise, throughout the description and any accompanying claims (where present), the words “comprise,” “comprising,” and the like are to be construed in an inclusive sense, that is, in the sense of “including, but not limited to.” Additionally, the words “herein,” “above,” “below,” and words of similar import, shall refer to this document as a whole and not to any particular portions. Where the context permits, words using the singular or plural number may also include the plural or singular number respectively. The word “or,” in reference to a list of two or more items, covers all of the following interpretations of the word: any of the items in the list, all of the items in the list, and any combination of the items in the list.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method and/or to provide the functionality as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods and/or provide functionality as described herein by executing software instructions in a program memory accessible to the processors.

Software and other modules may reside on servers, workstations, personal computers, tablet computers, image data encoders, image data decoders, PDAs, media players, PIDs and other devices suitable for the purposes described herein. Those skilled in the relevant art will appreciate that aspects of the system can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, network PCs, mini-computers, mainframe computers, and the like.

While processes or blocks of some methods are presented herein in a given order, alternative examples may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. In addition, while elements are at times shown as being performed sequentially, they may instead be performed simultaneously or in different sequences. It is therefore intended that the following claims are interpreted to include all such variations as are within their intended scope.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

The invention has a number of non-limiting aspects. Non-limiting aspects of the invention comprise:
1. A computer implemented method for registering markers applied on a face of an actor to a computer-based three-dimensional (3D) mesh representative of a face geometry of the actor, the method comprising:
   obtaining an animated face geometry comprising a plurality of frames of a computer-based 3D mesh representative of a face geometry of the actor, the 3D mesh comprising: for each of the plurality of frames, 3D locations of a plurality of vertices; and identifiers for a plurality of polygons, each polygon defined by ordered (e.g. clockwise or counter-clockwise) indices of a corresponding group of vertices;
   obtaining shot data of a face of actor with markers applied thereon, the shot data comprising first footage of the face captured over a series of shot data frames from a first orientation and second footage of the face captured from a second orientation over the series of shot data frames, the first and second orientations different than one another;
   performing a matrix decomposition on the plurality of frames of the 3D mesh to obtain a decomposition basis which at least approximately spans a range of motion of the vertices over the plurality of frames;
   selecting a shot data frame from among the series of shot data frames to be a neutral frame and generating a 3D face reconstruction based on the first footage and the second footage of the neutral frame;
   performing a solve operation to determine a solved 3D face geometry that approximates the 3D face reconstruction, the solved 3D face geometry parameterized by solved face geometry parameters comprising: a set of decomposition weights which, together with the decomposition basis, can be used to reconstruct the 3D mesh in a particular face geometry; a set of rotation parameters; and a set of translation parameters; and
   projecting 2D locations of the markers from the shot data onto the 3D mesh corresponding to the solved 3D face geometry using the shot data, wherein projecting the 2D locations of the markers from the shot data onto the 3D mesh corresponding to the solved face geometry comprises, for each marker, determining a set of marker registration parameters, the set of marker registration parameters comprising:
      a particular polygon identifier which defines a particular polygon of the 3D mesh onto which the marker is projected; and
      a set of registration parameters which defines where in the particular polygon the marker is projected.
2. A method according to aspect 1 or any other aspect herein wherein the polygons of the mesh are triangles defined by the indices of 3 corresponding vertices.
3. A method according to any one of aspects 1 and 2 or any other aspect herein wherein, for each marker, the set of parameters which defines where in the particular polygon the marker is projected comprises a set of barycentric coordinates.
4. A method according to any one of aspects 1 to 3 or any other aspect herein wherein performing the matrix decomposition comprises performing a principal component analysis (PCA) decomposition and wherein the blendshape basis comprises a PCA basis.
5. A method according to any one of aspects 1 to 4 or any other aspect herein wherein obtaining the animated face geometry comprises performing a multi-view reconstruction of on the face of the actor.
6. A method according to any one of aspects 1 to 5 or any other aspect herein wherein obtaining the animated face geometry comprises animation retargeting a performance of a different actor onto the actor.
7. The method of any one of aspects 1 to 6 or any other aspect herein wherein obtaining the animated face geometry is performed in advance and independently from obtaining shot data of the face of the actor.
8. The method of any one of aspects 1 to 7 or any other aspect herein wherein generating the 3D face reconstruction is further based on camera calibration data relating to cameras used to obtain the first footage and the second footage.
9. The method of aspect 8 wherein the camera calibration data comprises, for each camera, camera intrinsic parameters comprising any one or more of: data relating to the lens distortion, data relating to the focal length of the camera and data relating to the principal point.
10. The method of any one of aspects 8 to 9 wherein the camera calibration data comprises, for each camera, camera extrinsic parameters comprising camera rotation parameters and camera translation parameters that define a location and orientation of the camera in a 3D scene.
11. The method of any one of aspects 1 to 10 or any other aspect herein comprising obtaining at least some of the camera calibration data by capturing a common grid displayed in front of the first and second cameras.
12. The method of any one of aspects 1 to 11 or any other aspect herein wherein the first and second footages are captured by corresponding first and second cameras supported by a head-mounted camera device mounted to the head of the actor.
13. The method of any one of aspects 1 to 12 or any other aspect herein wherein generating the 3D face reconstruction comprises generating a shot data 3D mesh based on the first footage and the second footage of the neutral frame.
14. The method of any one of aspects 1 to 13 or any other aspect herein wherein generating the 3D face reconstruction comprises generating a depth map based on the first footage and the second footage of the neutral frame, wherein the depth map comprises an image comprising a two-dimensional array of pixels and a depth value assigned to each pixel.
15. The method of aspect 14 or any other aspect herein wherein generating the depth map comprises: generating a shot data 3D mesh based on the first footage and the second footage of the neutral frame; and rendering the shot data 3D mesh from the perspective of a notional camera.
16. The method of aspect 15 or any other aspect herein wherein rendering the shot data 3D mesh from the perspective of a notional camera comprises rendering the shot data 3D mesh from the perspective of a plurality of notional cameras, to thereby obtain a corresponding plurality of depth maps, each depth map comprising an image comprising a two-dimensional array of pixels and a depth value assigned to each pixel.
17. The method of any one of aspects 1 to 16 or any other aspect herein wherein performing the solve operation to determine the solved 3D face geometry comprises minimizing an energy function to thereby determine the solved face geometry parameters.
18. The method of aspect 17 or any other aspect herein wherein the energy function comprises a first term that assigns cost to a difference metric between the solved face geometry and the 3D face reconstruction.
19. The method of aspect 18 or any other aspect herein wherein the first term comprises, for each vertex of the 3D mesh, a difference between a depth dimension of the vertex of the solved face geometry and a corresponding depth value extracted from the 3D face reconstruction.
20. The method of aspect 19 or any other aspect herein comprising, for each vertex of the 3D mesh, extracting the corresponding depth value from the 3D face reconstruction, wherein extracting the corresponding depth value from the 3D face reconstruction comprises: determining, for the vertex, corresponding projected pixel coordinates; and interpolating depth values prescribed by the 3D face reconstruction at the corresponding projected pixel coordinates.
21. The method of aspect 20 or any other aspect herein wherein interpolating the depth values prescribed by the 3D face reconstruction comprises bilinear interpolation of the depth values prescribed by a plurality of pixels of a depth map.
22. The method of aspect 19 or any other aspect herein comprising, for each vertex of the 3D mesh, extracting the corresponding depth value from the 3D face reconstruction, wherein extracting the corresponding depth value from the 3D face reconstruction comprises ray tracing from an origin, through the vertex of the 3D mesh and onto a shot data mesh of the 3D face reconstruction.
23. The method of any one of aspects 19 to 22 or any other aspect herein wherein the first term comprises, for each vertex of the 3D mesh, application of a per-vertex mask to the difference between the depth dimension of the vertex of the solved face geometry and the corresponding depth value extracted from the 3D face reconstruction.
24. The method of aspect 23 or any other aspect herein wherein the per-vertex mask is a binary mask which removes from the first term vertices in which a confidence in the 3D face reconstruction is low.
25. The method of aspect 23 or any other aspect herein wherein the per-vertex mask is a weighted mask which assigns a weight to each vertex, a magnitude of the weight based on a confidence in the 3D face reconstruction at that vertex.
26. The method of any one of aspects 19 to 25 or any other aspect herein wherein the difference metric comprises a robust norm that switches between a L1 norm and a L2 norm based on a user-configurable parameter A.
27. The method of any one of aspects 18 to 26 or any other aspect herein wherein the energy function comprises a second term that assigns costs to solved face geometries that are unlikely based on using the animated face geometry as an animation prior.
28. The method of aspect 27 or any other aspect herein wherein the second term is based at least in part on a precision matrix computed from the animated face geometry.
29. The method of aspect 28 or any other aspect herein wherein the precision matrix is based at least in part on an inverse of a covariance matrix of the animated face geometry.
30. The method of any one of aspects 28 to 29 or any other aspect herein wherein the second term is based at least in part on a negative log likelihood computed from the precision matrix.
31. The method of any one of aspects 28 to 30 or any other aspect herein comprising:
   identifying a plurality of key points from among the plurality of vertices; and
   extracting a keypoint animation from the animated face geometry, the extracted keypoint animation comprising, for each of the plurality of frames, 3D locations of the key points; and
   computing the precision matrix based on the keypoint animation.
32. The method of aspect 31 or any other aspect herein wherein computing the precision matrix based on the keypoint animation comprises computing an inverse of a covariance matrix of the keypoint animation.
33. The method of any one of aspects 18 to 32 or any other aspect herein wherein the energy function comprises a third term comprising user-defined constraints.
34. The method of aspect 33 wherein the user-defined constraints comprise user-specified 2D or 3D locations for particular vertices and the third term assigns cost to deviations of the particular vertices from these 2D or 3D locations.
35. The method according to any one of aspects 17 to 34 or any other aspect herein wherein minimizing the energy function to thereby determine the solved face geometry parameters comprises:
   minimizing the energy function a first time while varying the rotation parameters and the translation parameters while maintaining the decomposition weights constant to thereby determine a first order set of rotation parameters and a first order set of translation parameters; and
   starting with the first orders set of rotation parameters and the first order set of translation parameters, minimizing the energy function a second time while varying the rotation parameters, the translation parameters and the decomposition weights to thereby determine a second order set of rotation parameters, a second order set of translation parameters and a first order set of decomposition weights.
36. The method according to aspect 35 or any other aspect herein wherein solved face geometry parameters comprise: the second order set of rotation parameters, the second order set of translation parameters and the first order set of decomposition weights.
37. The method according to aspect 35 or any other aspect herein wherein minimizing the energy function to thereby determine the solved face geometry parameters comprises:
   introducing one or more user-defined constraints into the energy function to thereby obtain an updated energy function;
   starting with the second order set of rotation parameters, the second order set of translation parameters and the first order set of decomposition weights; and
   minimizing the updated energy function while varying the rotation parameters, the translation parameters and the decomposition weights to thereby determine the solved face geometry parameters.
38. The method of any one of aspects 1 to 37 or any other aspect herein wherein performing the solve operation to determine the solved 3D face geometry comprises:
   for each of a number of iterations:
      starting with different initial rotation parameters and different initial translation parameters; and
      minimizing an energy function to thereby determine candidate solved face geometry parameters comprising: a set of candidate decomposition weights; a set of candidate rotation parameters; and a set of candidate translation parameters;
   after the plurality of iterations, determining the solved face geometry parameters based on the candidate solved face geometry parameters.
39. The method of any one of aspects 1 to 38 wherein projecting the 2D locations of the markers from the shot data onto the 3D mesh corresponding to the solved face geometry comprises, for each marker:
   determining a first pixel representative of a location of the marker in the first footage of the neutral frame;
   determining a second pixel representative of a location of the marker in the second footage of the neutral frame;
   triangulating the first and second pixels using camera calibration data to thereby obtain 3D coordinates for the marker; and
      ray tracing from an origin through the 3D coordinates of the marker and onto the 3D mesh corresponding to the solved face geometry, to thereby determine a location on the 3D mesh corresponding to the solved face geometry onto which the marker is projected.
40. The method of aspect 39 or any other aspect herein wherein determining the first pixel representative of a location of the marker in the first footage of the neutral frame comprises determining the first pixel to be a center of the marker in the first footage of the neutral frame.
41. The method of any one of aspects 39 to 40 or any other aspect herein wherein determining the second pixel representative of a location of the marker in the second footage of the neutral frame comprises determining the second pixel to be a center of the marker in the second footage of the neutral frame.
42. The method of aspect 39 or any other aspect herein comprising determining 3D positions of the markers on a neutral configuration of the 3D mesh based on the marker registration parameters.
43. The method of aspect 42 or any other aspect herein wherein determining 3D positions of the markers on the neutral configuration of the 3D mesh comprises, for each marker, performing a calculation according to:

$${\vec{Pos}}_{k} = {c}_{1} ( {\vec{V}}_{1 k} ) + {c}_{2} ( {\vec{V}}_{2 k} ) + {c}_{3} ( {\vec{V}}_{3 k} )$$

where: k is the polygon identifier of the particular polygon of the 3D mesh onto which the marker is projected; (c₁, c₂, c₃) are the set of parameters which defines wherein the particular polygon the marker is projected; and [symbol] are locations of the vertices that define the kth polygon of the neutral configuration of the 3D mesh.
44. The method of aspect 42 or any other aspect herein wherein determining 3D positons of the marks on the neutral configuration of the 3D mesh comprises, for each marker, performing a calculation according to:

$${\vec{Pos}}_{k} = {\sum }_{i = 1}^{N} {c}_{i} ( {\vec{V}}_{ik} )$$

where: k is the polygon identifier of the particular polygon of the 3D mesh onto which the marker is projected; N is the number of vertices that define the polygon, (c₁, c₂, . . . c_{N}) are the set of parameters which defines wherein the particular polygon the marker is projected; and [symbol] are locations of the vertices that define the k^{th} polygon of the neutral configuration of the 3D mesh.
45. Methods having any new and inventive steps, acts, combination of steps and/or acts or sub-combination of steps and/or acts as described herein.
46. Apparatus comprising one or more processors configured (e.g. by suitable software) to perform any of the methods of any of aspects 1 to 45.
47. A computer program product comprising a non-transient computer-readable storage medium having data stored thereon representing software executable by a process, the software comprising instructions to perform any of the methods of any of aspects 1 to 45.

While a number of exemplary aspects and embodiments have been discussed 5 above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A computer implemented method for registering markers applied on a face of an actor to a computer-based three-dimensional (3D) mesh representative of a face geometry of the actor, the method comprising:
obtaining an animated face geometry comprising a plurality of frames of a computer-based 3D mesh representative of a face geometry of the actor, the 3D mesh comprising: for each of the plurality of frames, 3D locations of a plurality of vertices; and identifiers for a plurality of polygons, each polygon defined by ordered (e.g. clockwise or counter-clockwise) indices of a corresponding group of vertices;
obtaining shot data of a face of actor with markers applied thereon, the shot data comprising first footage of the face captured over a series of shot data frames from a first orientation and second footage of the face captured from a second orientation over the series of shot data frames, the first and second orientations different than one another;
performing a matrix decomposition on the plurality of frames of the 3D mesh to obtain a decomposition basis which at least approximately spans a range of motion of the vertices over the plurality of frames;
selecting a shot data frame from among the series of shot data frames to be a neutral frame and generating a 3D face reconstruction based on the first footage and the second footage of the neutral frame;
performing a solve operation to determine a solved 3D face geometry that approximates the 3D face reconstruction, the solved 3D face geometry parameterized by solved face geometry parameters comprising: a set of decomposition weights which, together with the decomposition basis, can be used to reconstruct the 3D mesh in a particular face geometry; a set of rotation parameters;
and a set of translation parameters; and
projecting 2D locations of the markers from the shot data onto the 3D mesh corresponding to the solved 3D face geometry using the shot data, wherein projecting the 2D locations of the markers from the shot data onto the 3D mesh corresponding to the solved face geometry comprises, for each marker, determining a set of marker registration parameters, the set of marker registration parameters comprising:
a particular polygon identifier which defines a particular polygon of the 3D mesh onto which the marker is projected; and
a set of registration parameters which defines where in the particular polygon the marker is projected.

2. A method according to claim 1 wherein the polygons of the mesh are triangles defined by the indices of 3 corresponding vertices.

3. A method according to claim 1 wherein, for each marker, the set of parameters which defines where in the particular polygon the marker is projected comprises a set of barycentric coordinates.

4. A method according to claim 1 wherein performing the matrix decomposition comprises performing a principal component analysis (PCA) decomposition and wherein the blendshape basis comprises a PCA basis.

5. A method according to claim 1 wherein obtaining the animated face geometry comprises performing a multi-view reconstruction of on the face of the actor.

6. A method according to claim 1 wherein obtaining the animated face geometry comprises animation retargeting a performance of a different actor onto the actor.

7. The method of claim 1 wherein obtaining the animated face geometry is performed in advance and independently from obtaining shot data of the face of the actor.

8. The method of claim 1 wherein generating the 3D face reconstruction is further based on camera calibration data relating to cameras used to obtain the first footage and the second footage.

9. The method of claim 8 wherein the camera calibration data comprises, for each camera, camera intrinsic parameters comprising any one or more of: data relating to the lens distortion, data relating to the focal length of the camera and data relating to the principal point.

10. The method of claim 8 wherein the camera calibration data comprises, for each camera, camera extrinsic parameters comprising camera rotation parameters and camera translation parameters that define a location and orientation of the camera in a 3D scene.

11. The method of claim 1 comprising obtaining at least some of the camera calibration data by capturing a common grid displayed in front of the first and second cameras.

12. The method of claim 1 wherein the first and second footages are captured by corresponding first and second cameras supported by a head-mounted camera device mounted to the head of the actor.

13. The method of claim 1 wherein generating the 3D face reconstruction comprises generating a shot data 3D mesh based on the first footage and the second footage of the neutral frame.

14. The method of claim 1 wherein generating the 3D face reconstruction comprises generating a depth map based on the first footage and the second footage of the neutral frame, wherein the depth map comprises an image comprising a two-dimensional array of pixels and a depth value assigned to each pixel.

15. The method of claim 14 wherein generating the depth map comprises: generating a shot data 3D mesh based on the first footage and the second footage of the neutral frame; and rendering the shot data 3D mesh from the perspective of a notional camera.

16. The method of claim 15 wherein rendering the shot data 3D mesh from the perspective of a notional camera comprises rendering the shot data 3D mesh from the perspective of a plurality of notional cameras, to thereby obtain a corresponding plurality of depth maps, each depth map comprising an image comprising a two-dimensional array of pixels and a depth value assigned to each pixel.

17. The method of claim 1 wherein performing the solve operation to determine the solved 3D face geometry comprises minimizing an energy function to thereby determine the solved face geometry parameters. The method of claim 17 wherein the energy function comprises a first term that 18. assigns cost to a difference metric between the solved face geometry and the 3D face reconstruction.

19. The method of claim 18 wherein the first term comprises, for each vertex of the 3D mesh, a difference between a depth dimension of the vertex of the solved face geometry and a corresponding depth value extracted from the 3D face reconstruction.

20. The method of claim 19 comprising, for each vertex of the 3D mesh, extracting the corresponding depth value from the 3D face reconstruction, wherein extracting the corresponding depth value from the 3D face reconstruction comprises: determining, for the vertex, corresponding projected pixel coordinates; and interpolating depth values prescribed by the 3D face reconstruction at the corresponding projected pixel coordinates.
